(19) United States
(12) Patent Application Publication
(10) Pub. No.: US 2025/0388762 A1
(43) Pub. Date: Dec. 25, 2025

(54) ANTIBACTERIAL COATING

(71) Applicant: LUXEMBOURG INSTITUTE OF SCIENCE AND TECHNOLOGY (LIST), Esch-sur-Alzette (LU)

(72) Inventors: Jean-Sébastien THOMANN, Esch-sur-Alzette (LU); David DUDAY, Esch-sur-Alzette (LU)

(21) Appl. No.: 18/880,837

(22) PCT Filed: Jul. 6, 2023
(86) PCT No.: PCT/EP2023/068669

§ 371 Date: Jan. 2, 2025

(30) Foreign Application Priority Data
Jul. 6, 2022 (LU) LU502468

(51) Int. Cl. C09D 5/14; B05D 3/00; B05D 3/10; B05D 7/00; C08K 3/04; C08K 3/24; C08K 5/07; C09D 7/40; C09D 7/61; C09D 7/65; C09D 7/80; C09D 129/04

(52) U.S. Cl. CPC C09D 5/14; B05D 3/002; B05D 3/108; B05D 7/544; C08K 3/042; C08K 3/24; C08K 5/07; C09D 7/61; C09D 7/65; C09D 7/67; C09D 7/80; C09D 129/04; B05D 2401/20; B05D 2518/00

(57) ABSTRACT

The present disclosure relates to an antimicrobial coating comprising one or more biosourced polycationic polymers and lignin nanoparticles dispersed into polyvinyl alcohol, remarkable in that said antimicrobial coating further comprises a dialdehyde or a boron-based compound.

### FIELD OF THE DISCLOSURE

The present disclosure relates to antimicrobial coatings comprising lignin nanoparticles, to a method for producing such antimicrobial coatings and to a process for coating a substrate with such antimicrobial coatings. The use of the antimicrobial coatings of the present disclosure is also described.

### BACKGROUND OF THE DISCLOSURE

In the context of providing interesting mechanical properties in addition to properties such as antioxidizing and/or antibacterial features to hydrogels, a combination between, on one hand, polyvinyl alcohol (PVA) which is a water-soluble molecule, and on the other hand, biosourced polycationic polymers (BPcP) like chitosan (Ch) is quite known. Such PVA/BPcP blend hydrogels have been for example reported to be used for the controlled release of drugs, due to their low toxicity and high biocompatibility.

It appears that lignin, which is the second most abundant natural polymer next to cellulose, comprises a huge number of phenolic constructions that enable it to act as an effective antioxidant. Lignin has also a certain biocidal activity, which makes it a more attractive compound than silver nanoparticles due to its reduced environmental impact.

In a first study by Yang. W., entitled “Antioxidant and antibacterial lignin nanoparticles in polyvinyl alcohol/chitosan films for active packaging” (Industrial Crops and Products, 2016, 94, 800-811), it was found that ternary polymeric films based on PVA, Ch, and pristine lignin (namely lignin-containing multiple reactive hydroxyl groups) nanoparticles added at 1 wt. % or 3 wt. %, and prepared by solvent casting, show a good antibacterial activity, especially against plant or fruit pathogens. The microstructure of the chitosan-based films shows cavities and agglomerates at a high concentration (3 wt. %) of lignin nanoparticles in the chitosan matrix.

In a second study by Yang W., entitled “Polyvinyl alcohol/chitosan hydrogels with enhanced antioxidant and antibacterial properties induced by lignin nanoparticles” (Carbohydrate Polymers, 2018, 181, 275-284), it was shown that hydrogels of PVA and Ch comprising between 1 wt. % and 3 wt. % of nanoparticles of pristine lignin, were prepared by applying a freezing-thaw procedure. The pristine lignin nanoparticles show a diameter ranging from 40 nm to 60 nm. The strong interaction occurring between the PVA/Ch blend and the pristine lignin nanoparticles prevents the PVA molecules from moving and dissolving into water, promoting thus the crosslinking effect. As the PVA structure is maintained, the pristine lignin nanoparticles act as a release agent in synergy with Ch, making the hydrogel effective in terms of antioxidative response and effective against E. coli and S. aureus bacteria strains. Once again, the results from the microstructural, thermal and mechanical characterization of the hydrogels demonstrated that the lowest amount of the pristine lignin nanoparticles (1 wt. %) is beneficial, whereas the presence of agglomerates at high concentration (3 wt. %) limited the effect of the hydrogel.

In CN 113652047, a ternary composite material comprising a blend of PVA and Ch with lignin nanoparticles of the size ranging between 200 nm and 800 nm was prepared. Such a ternary composite material is used as active composite film, active packaging paper or paperboard with ultraviolet shielding and synergistic flame-retardant functions. It was revealed that the ternary composite material when comprising 1 wt. % of lignin nanoparticles, improves the structure between the fibres so that the lignin nanoparticles can fully enter the pores. When the ternary composite material comprises 3 wt. % of lignin nanoparticles, it allows the generation of pores between the fibres and almost all the lignin nanoparticles enter the pores of the fibres.

The present disclosure has for objective to develop an antimicrobial coating with a homogeneous distribution of lignin nanoparticles so that the coating can adhere to a surface of a substrate.

### SUMMARY OF THE DISCLOSURE

According to a first aspect, the disclosure provides an antimicrobial coating comprising one or more biosourced polycationic polymers (BPcP) and lignin nanoparticles dispersed into polyvinyl alcohol remarkable in that said antimicrobial coating further comprises a dialdehyde or a boron-based compound, preferably a dialdehyde.

Surprisingly, it has been found that the PVA cross-linked structure with a dialdehyde or a boron-based compound, preferably a dialdehyde, allows a good compromise between mechanical strength and chemical stability. As the durability of these PVA-based coatings has increased, their suitability for biomedical application has also increased. The use of a dialdehyde or a boron-based compound, preferably of a dialdehyde, also allows for avoiding issues with cytotoxicity. The reinforcement of the chemical structure is also quite advantageous since it allows the incorporation of more lignin nanoparticles in comparison with what is described in the state of the art. Thus, it will be demonstrated that up to 10 wt. % of lignin nanoparticles can be incorporated into the coating of the present disclosure, improving at the same time the biocidal activity of the coating.

For example, the dialdehyde is glyoxal.

Advantageously, said antimicrobial coating further comprises polyacrylic acid. The incorporation of polyacrylic acid (PAA) along with a dialdehyde or a boron-based compound has been used to reinforce further the mechanical strength and chemical stability. For example, said antimicrobial coating further comprises polyacrylic acid in an amount ranging between 5 wt. % and 30 wt. % based on the total weight of the coating, more preferably between 6 wt. % and 25 wt. %, or between 7 wt. % and 20 wt. %.

With preference, said lignin nanoparticles are Kraft lignin nanoparticles.
For example, said Kraft lignin nanoparticles have an average diameter size ranging from 9 nm up to 70 nm as determined by imaging techniques. For example, the imaging techniques are Scanning Electron Microscopy (SEM) and/or Helium Ion Microscopy (HIM). SEM can be used for the nanoparticles presenting a bigger average diameter size while HIM is used for the nanoparticles presenting a smaller average diameter size. In general, a size of above 15 nm can be well-detected by SEM. As the KL nanoparticles generated by DMSO have in general a smaller average diameter size than the KL nanoparticles generated with THF, HIM experiments are carried out on the KL nanoparticles generated with DMSO. For KL nanoparticles, HIM experiments provide more precise results in the determination of the size. For example, the Kraft lignin nanoparticles have an average diameter size ranging from 9 nm up to 14 nm as determined by Helium Ion Microscopy; or from 10 nm up to 13 nm. For example, the Kraft lignin nanoparticles have an average diameter size ranging from 15 nm up to 70 nm as determined by Scanning Electron Microscopy; or from 15 nm up to 60 nm; or from 15 nm up to 55 nm; or from 15 nm up to 50 nm; or from 15 nm up to 45 nm; or from 15 nm up to 40 nm; or from 15 nm up to 35 nm.
For example, said Kraft lignin nanoparticles have a glass transition temperature which is superior to the glass transition temperature of the Kraft lignin as determined by differential scanning calorimetry. Advantageously, the glass transition temperature which is superior to the glass transition temperature of the Kraft lignin as determined by differential scanning calorimetry is at least 150° C. For example, the glass transition temperature which is superior to the glass transition temperature of the Kraft lignin as determined by differential scanning calorimetry is a second glass transition temperature and said Kraft lignin nanoparticles have a first glass transition temperature as determined by differential scanning calorimetry. For example, said first glass transition temperature is ranging between 110° C. and 130° C. as determined by differential scanning calorimetry.
For example, said Kraft lignin nanoparticles have a transmittance taken at a wavelength of 600 nm ranging between 40% and 80% as determined by absorption analysis, preferably between 45% and 75%.
For example, said Kraft lignin nanoparticles have a Young's modulus ranging between 1.0 GPa and 6.0 GPa as determined by atomic force microscopy, preferentially between 1.4 GPa and 5.1 GPa, more preferentially between 1.5 GPa and 5.0 GPa.
For example, said Kraft lignin nanoparticles have a three-dimensional structure that comprises at least two types of π-π stacking, as determined by UV-Visible analysis.
For example, said Kraft lignin nanoparticles have a polydispersity index ranging between 0.05 and 0.20 as determined by Dynamic Light Scattering method, preferably between 0.07 and 0.18, more preferably between 0.09 and 0.16, even more preferably between 0.11 and 0.14.

Advantageously, said lignin nanoparticles are present in an amount ranging between 0.1 wt. % and 10 wt. % of the total weight of the coating, preferably between 0.2 wt. % and 9 wt. %, more preferably between 0.3 wt. % and 8.5 wt. %, even more preferably between 0.4 wt. % and 8 wt. %, most preferably between 0.5 wt. % and 7.5 wt. %, even most preferably between 0.6 wt. % and 7 wt. %.

For example, said Kraft lignin nanoparticles are present in an amount ranging between 0.1 wt. % and 10 wt. % of the total weight of the coating, preferably between 0.2 wt. % and 9 wt. %, more preferably between 0.3 wt. % and 8.5 wt. %, even more preferably between 0.4 wt. % and 8 wt. %, most preferably between 0.5 wt. % and 7.5 wt. %, even most preferably between 0.6 wt. % and 7 wt. %.

Advantageously, said polyvinyl alcohol is present in the coating in an amount ranging between 30 wt. % and 90 wt. % based on the total weight of the coating, preferably between 35 wt. % and 85 wt. %, more preferably between 40 wt. % and 80 wt. %, even more preferably between 45 wt. % and 75 wt. %, most preferably between 50 wt. % and 70 wt. %, or between 50 wt. % and 65 wt. %.

For example, said dialdehyde or said boron-based compound is present in an amount ranging between 3 wt. % and 15 wt. % based on the total weight of the coating, preferably between 4 wt. % and 14 wt. %, more preferably between 5 wt. % and 13 wt. %.

For example, the one or more biosourced polycationic polymers are present in an amount ranging between 1 wt. % and 40 wt. % based on the total weight of the coating, preferably between 5 wt. % and 35 wt. %, more preferably between 10 wt. % and 30 wt. %.

Advantageously, said antimicrobial coating further comprises graphene oxide. With preference, said graphene oxide is in the form of nanoflakes.

For example, said graphene oxide is present in an amount ranging between 0.1 wt. % and 5 wt. % of the total weight of the coating, preferably between 0.2 wt. % and 2.5 wt. %, more preferably between 0.3 wt. % and 2 wt. %.

Advantageously, said antimicrobial coating further comprises both polyacrylic acid and graphene oxide, or preferably polyacrylic acid and graphene oxide under the form of nanoflakes. For example, when said antimicrobial coating further comprises both polyacrylic acid and graphene oxide, the amount of polyacrylic acid is ranging between 5 wt. % and 30 wt. % based on the total weight of the coating, more preferably between 6 wt. % and 25 wt. %, or between 7 wt. % and 20 wt. %; and the amount of graphene oxide is ranging between 0.1 wt. % and 5 wt. % of the total weight of the coating, preferably between 0.2 wt. % and 2.5 wt. %, more preferably between 0.3 wt. % and 2 wt. %.

According to a second aspect, the disclosure relates to a method for producing an antimicrobial coating as defined in the first aspect, remarkable in that said method comprises the following steps:
a. providing an aqueous solution of lignin nanoparticles,
b. heating said aqueous solution of lignin nanoparticles at a temperature ranging between 60° C. and 80° C.;
c. adding polyvinyl alcohol to said aqueous solution;
d. adding one or more biosourced polycationic polymers;
e. adding a dialdehyde or a boron-based compound once said one or more biosourced polycationic polymers added in step (d) are dissolved;
   wherein steps (b) to (e) are conducted under stirring.

Advantageously, a step of adding polyacrylic acid is performed between steps (c) and (d).

According to a third aspect, the disclosure relates to a process for coating a substrate with an antimicrobial coating as defined in the first aspect and/or as produced according to the second aspect, said process is remarkable in that it comprises the following steps:
i. providing a substrate with a surface-to-be-coated;
ii. cleaning said surface under cleaning conditions to obtain a clean surface-to-be-coated;
iii. applying an aqueous mixture of one or more cationic polymers and ethanol onto said clean surface-to-be-coated to obtain an activated surface-to-be-coated;
iv. drying the activated surface-to-be-coated;
v. coating the activated surface-to-be-coated with an antimicrobial coating, as defined in the first aspect and/or as produced according to the second aspect, and
vi. curing to obtain the coated surface.

For example, the cleaning conditions of step (b) comprise the sub-steps of immersing the substrate in an alkaline soap solution, sonicating and then rinsing with deionized water followed by drying.

For example, said process further comprises a step of dry-cleaning the surface-to-be-coated with an inert gas before step (c), preferably with nitrogen and/or argon.

Advantageously, the aqueous mixture of the one or more cationic polymers and ethanol comprises an amount of cationic polymer ranging between 5 wt. % and 30 wt. % of the total weight of said aqueous mixture of the one or more cationic polymers and ethanol, preferably between 10 wt. % and 25 wt. % or between 15 wt. % and 20 wt. %. For example, one cationic polymer is poly(ethylene imine).

For example, the step (iv) of drying is performed at a temperature ranging between 30° C. and 70° C., or between 40° C. and 60° C.

Advantageously, the step (v) of coating is performed through one method selected from bar-coating, blade-coating, or slot die-coating, preferably through bar-coating.

With preference, the step (vi) of curing is performed during a period ranging between 1 hour and 12 hours, or between 2 hours and 10 hours.

For example, the step of curing is performed at a temperature ranging between 60° C. and 120° C., or between 70° C. and 110° C.

With preference, said substrate has a surface area of at least 50 cm², more preferably of at least 75 cm², even more preferably of at least 90 cm², most preferably of at least 250 cm², even most preferably of at least 500 cm², or at least 600 cm².

Advantageously, said substrate is in a material selected from plastic, metal, steel, ceramic, wood, textile, or silicate; preferably plastic. For example, plastic is Kapton; or steel is stainless steel.

According to a fourth aspect, the disclosure relates to a use of an antimicrobial coating, as defined in the first aspect and/or as produced according to the second aspect, for protecting an internal surface of a space shuttle.

According to a fifth aspect, the disclosure relates to a use of an antimicrobial coating, as defined in the first aspect and/or as produced according to the second aspect, for protecting an external surface of a medical device.

According to a sixth aspect, the disclosure relates to a use of an antimicrobial coating, as defined in the first aspect and/or as produced according to the second aspect, for protecting an external surface of a textile. With preference, said textile is fabric seat.

According to a seventh aspect, the disclosure relates to a use of an antimicrobial coating, as defined in the first aspect and/or as produced according to the second aspect, for protecting a plastic material.

According to an eighth aspect, the disclosure relates to a use of an antimicrobial coating, as defined in the first aspect and/or as produced according to the second aspect, for protecting a ceramic material. With preference, said ceramic material is glass.

### DESCRIPTION OF THE FIGURES

FIG. 1: DLS spectrum of KL nanoparticles fabricated using DMSO.

FIG. 2: SEM image of KL nanoparticles fabricated using DMSO.

FIG. 3: Helium Ion Microscopy (HIM) image of KL nanoparticles fabricated using DMSO.

FIG. 4: DLS spectrum of KL nanoparticles fabricated using THF.

FIG. 5: SEM image of KL nanoparticles fabricated using THF.

FIG. 6 is a HIM image of KL nanoparticles fabricated using THF.

FIG. 7: Transmittance measurements of KL nanoparticles of the present disclosure.

FIG. 8: UV Visible spectrum of KL nanoparticles of the present disclosure.

FIG. 9: Differential Scanning calorimetry (DSC) curves of KL nanoparticles of the disclosure.

FIG. 10: Thermogravimetric Analysis (TGA) curves of KL nanoparticles of the disclosure.

FIG. 11: AFM studies showing the size and Young's modulus of raw KL.

FIG. 12: AFM studies showing the size and Young's modulus of KL nanoparticles generated using THF.

FIG. 13: AFM studies showing the size and Young's modulus of KL nanoparticles generated using DMSO.

FIG. 14: Correlation between size distribution and Young's modulus of the KL nanoparticles FIG. 15: SEM images of PVA-based coatings (with WP3 and WP4) embedding KL nanoparticles.

FIG. 16: ToF-SIMS analyses in positive mode on PVA-based coatings embedding lignin nanoparticles.

FIG. 17: ToF-SIMS analyses in negative mode on PVA-based coatings embedding lignin nanoparticles.

FIG. 18: XPS analyses on PVA-based coatings embedding lignin nanoparticles.

FIG. 19: Average roughness of a steel surface coated with WP4 as determined by profilometry techniques.

FIG. 20: Average roughness of a Kapton surface coated with WP4 as determined by profilometry techniques.

FIG. 21: Antimicrobial activity of E. coli measured on a substrate exhibiting a surface area of 100 cm², with the coefficient R indicating the logarithm reduction of the number of surviving micro-organisms in cells/cm² according to the different coatings.

FIG. 22: Antimicrobial activity of S. aureus measured on a substrate exhibiting a surface area of 100 cm², with the coefficient R indicating the logarithm reduction of the number of surviving micro-organisms in cells/cm² according to the different coatings.

FIG. 23: Antimicrobial activity of E. coli measured on a substrate exhibiting a surface area of 625 cm², with the coefficient R indicating the logarithm reduction of the number of surviving micro-organisms in cells/cm² according to the different coatings.

FIG. 24: Antimicrobial activity of S. aureus measured on a substrate exhibiting a surface area of 625 cm², with the coefficient R indicating the logarithm reduction of the number of surviving micro-organisms in cells/cm² according to the different coatings.

### DETAILED DESCRIPTION OF THE DISCLOSURE

For the purpose of the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g., from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

The disclosure relates to an antimicrobial coating comprising one or more biosourced polycationic polymers and lignin nanoparticles dispersed into polyvinyl alcohol, remarkable in that said antimicrobial coating further comprises a dialdehyde or a boron-based compound. For example, the dialdehyde can be glyoxal and the boron-based compound can be boric acid. With preference, the antimicrobial coating comprises one or more biosourced polycationic polymers such as chitosan, lignin nanoparticles dispersed into polyvinyl alcohol and a dialdehyde.

The dialdehyde or the boron-based compound can be present in an amount ranging between 3 wt. % and 15 wt. % based on the total weight of the coating, preferably between 4 wt. % and 14 wt. %, more preferably between 5 wt. % and 13 wt. %, even more preferably between 6 wt. % and 12 wt. %.

The one or more biosourced polycationic polymers are present in an amount ranging between 0.5 wt. % and 40 wt. %, or between 1 wt. % and 40 wt. % based on the total weight of the coating, preferably between 5 wt. % and 35 wt. %, more preferably between 10 wt. % and 30 wt. %. In particular, the one or more biosourced polycationic polymers can be selected from one or more of chitosan, gelatine, cellulose, dextran, poly(2-N-N-dimethylaminoethylmethacrylate, poly-L-lysine, poly ethyleneimine, poly(amidoamine), preferably, a biosourced polycationic polymer can be chitosan.

In order to reinforce the antimicrobial effect, graphene oxide, preferably in the form of nanoflakes can be added. For example, graphene oxide can be present in an amount ranging between 0.1 wt. % and 10 wt. %, or between 0.1 wt. % and 5 wt. % of the total weight of the antimicrobial coating, preferably between 0.2 wt. % and 2.5 wt. %, more preferably between 0.3 wt. % and 2 wt. %.

The antimicrobial coating is produced by heating an aqueous solution of lignin nanoparticles at a temperature ranging between 60° C. and 80° C. Once the solution has reached this temperature, polyvinyl alcohol (PVA) is added under stirring, followed by one or more biosourced polycationic polymers such as chitosan. Then, crosslinking is performed by adding under stirring a dialdehyde or a boron-based compound once said one or more biosourced polycationic polymers are dissolved. This allows the reinforcement of the chemical structure of the coating and provides therefore for the incorporation of more lignin nanoparticles in comparison with what is described in the state of the art. In particular, the lignin nanoparticles can be Kraft lignin (KL) nanoparticles. For example, said polyvinyl alcohol is present in the coating in an amount ranging between 30 wt. % and 90 wt. % based on the total weight of the coating, preferably between 35 wt. % and 85 wt. %, more preferably between 40 wt. % and 80 wt. %, even more preferably between 45 wt. % and 75 wt. %, most preferably between 50 wt. % and 70 wt. %, or between 50 wt. % and 65 wt. %.

Advantageously, said lignin nanoparticles are present in an amount ranging between 0.1 wt. % and 10 wt. % of the total weight of the coating, preferably between 0.2 wt. % and 9 wt. %, more preferably between 0.3 wt. % and 8.5 wt. %, even more preferably between 0.4 wt. % and 8 wt. %, most preferably between 0.5 wt. % and 7.5 wt. %, even most preferably between 0.6 wt. % and 7 wt. %.

In general, in order to reinforce further the mechanical strength and stability, the cross-linker which is a dialdehyde or a boron-based compound is supplemented by polyacrylic acid (PAA). Polyacrylic acid (PAA) can be further added, for example after having added the PVA. For example, said antimicrobial coating further comprises polyacrylic acid in an amount ranging between 5 wt. % and 30 wt. % based on the total weight of the coating, more preferably between 6 wt. % and 25 wt. %, or between 7 wt. % and 20 wt. %, or between 8 wt. % and 10 wt. %.

### Synthesis of Kraft Lignin (KL) Nanoparticles

Kraft lignin nanoparticles are generated as follows. KL is provided in a first step (A). Then, in a second step (B), an organic solution of said KL is prepared by the dissolution of said KL in a single organic solvent. To form the nanoparticles, the solvent-shifting technique requires the addition of an anti-solvent, namely a solvent with no dissolving power of the KL, to trigger the self-assembly and/or the dispersion and thus the formation of colloidal particles. So, in a third step (C), the solution of step (B) is mixed with an antisolvent being or comprising water. In the present disclosure, the organic solution of KL is added to the antisolvent during the third step (C). The addition of the organic solution in water corresponds to the addition of the organic solution in a medium that quenches the growth of the nanoparticles. This drastic increase in the antisolvent reservoir is, therefore, one of the reasons why it is possible to generate nanoparticles of KL having a small size.

With preference, step (C) of mixing the KL solution into water is performed under an inert atmosphere, for instance under argon and/or nitrogen. This prevents the inclusion of air in the medium and subsequently the formation of foam.

The addition of the KL solution in the organic solvent during step (C) is performed dropwise or rapidly.

When the organic solution of KL is added to water, the formation of the KL nanoparticles is carried out instantaneously.

In a preferred implementation of the method of the present disclosure, steps (B) and (C) are performed in a single reactor, or, in other terms, the manufacture of the colloidal dispersion of KL nanoparticles is a one-pot method. A “one-pot method” stands for a method in which the operations related to the dissolution of KL into one or more organic solvents and to the mixing of the solution with an antisolvent being or comprising water are carried out in the same vessel.

By acting on one or more of the five different parameters, which are the solvents, the KL concentration, the amount of the antisolvent, the temperature and/or the stirring speed at which the mixing of step (c) is carried out, it is possible to control the size of the KL nanoparticles. There is a synergistic effect with regard to the size of the KL nanoparticles when those five parameters are under control.

The narrow values of the PDI (ranging between 0.05 and 0.20) for the KL nanoparticles with a size ranging between 15 nm and 200 nm is to be highlighted.

Additionally, the method of the present disclosure allows for obtaining homogenous KL nanoparticles which do not coalesce together, nor aggregate together. This allows obtaining KL nanoparticles with a well distinguishable morphology (notably by using SEM or HIM analysis). Also, such KL nanoparticles have a good distribution and a good dispersion, notably when used as reinforcing filler for polymer nanocomposites.

### 1^{st} Parameter: Effect of the Solvent

The first parameter concerns the choice of the organic solvent in which KL lignin must be dissolved before being added to the antisolvent. The size of the nanoparticles and the nuclei formation is completely dependent on the diffusion between the antisolvent, i.e. the water, and the organic solvent. The faster is the diffusion, the smaller is the size of the nuclei. Miscibility of DMSO (log Kow: −1.35; δ_{d}=18.4 MPa^{0.5}; δₚ=16.4 MPa^{0.5}; δ^{h}=10.2 MPa^{0.5}) with water is much greater than the THF (log Kow: 0.46; δ_{d}=16.8 MPa^{0.5}; δₚ=5.7 MPa^{0.5}; δₕ=8.0 MPa^{0.5}). Therefore, the diffusion will be faster in the DMSO system than in the THF system. This leads to the formation of smaller nuclei in the DMSO system than in the THF system at the same initial lignin concentration. Assuming that the initial concentration is the same, the number of smaller nuclei in the DMSO system will be higher than the number of smaller nuclei in the THF system. This behaviour predominantly affects the final size of KL nanoparticles.

Moreover, it is advantageous that the organic solvent is dried or anhydrous before it is used to dissolve KL.

### 2^{nd} Parameter: Effect of the KL Concentration

The second parameter relates to the initial concentration of KL in the organic solution. To obtain KL nanoparticles with an average diameter size ranging between 15 nm and 200 nm, as determined by Scanning Electron Microscopy studies, and preferably ranging between 15 nm to 70 nm, the KL concentration in the organic solution can be ranging between 15 mg/ml and 55 mg/mL. Advantageously, the KL concentrations in the organic solution can be ranging between 17 mg/mL and 53 mg/mL, more preferentially between 20 mg/ml and 50 mg/mL.

Increasing the KL concentration results in increasing the KL nanoparticles size.

### 3^{rd} Parameter: Effect of the Amount of Anti-Solvent (MilliQ Water)

The third parameter concerns the volume of the water in which the organic solution of KL is added. By increasing the amount of antisolvent (i.e. water), it appears that the KL nanoparticles will be more dispersed in the medium, which has for effect to decrease the number of the phenomenon of coalescence and/or Ostwald ripening. When the water reservoir increases, the nanoparticles have more space between each other, which means that their growth will be hindered. This effect can be observed in any organic solvents chosen for dissolving KL.

Thus, advantageously, the volume ratio between the antisolvent and the solution of step (b) is ranging between 0.3 and 2.5.

### 4^{th} Parameter: Effect of the Temperature

The fourth parameter relates to the temperature at which the addition of the organic solution of KL onto the water is performed. This parameter is a function of the dissolving power of the organic solvent and the miscibility between the organic solvent and the antisolvent.

When a solvent with a poor dissolving power is used, increasing the temperature is a way to increase the phenomenon of coalescence and/or Ostwald ripening and thus the size of the KL nanoparticles is increasing. For instance, solvents with a poor dissolving power have a partition coefficient of at least −0.50, preferably at least −0.40, more preferably at least −0.30 and/or a dipole moment inferior to 3 D (<1.000692285*10⁻²⁹ Cm). Advantageously, such solvents can be 1,4-dioxane, dichloromethane, THF, ethyl acetate and/or acetone, more preferably THF. In this case, the mixing temperature is preferably ranging between 1° C. to 60° C., preferably between 10° C. to 30° C.

However, when a solvent with a good dissolving power is used, the increase in temperature results in increasing the diffusion between the solvent and the water, which leads to more space between the KL nanoparticles in formation and therefore, helps to obtain KL nanoparticles with a low average diameter size since coalescence and/or Ostwald ripening are avoided. For instance, solvents with high dissolving power have a partition coefficient inferior to −0.50, preferably inferior to −0.60, more preferably inferior to −0.70 and/or are highly polar with a dipole moment superior to 3 D (>1.000692285*10⁻²⁹ Cm). Advantageously, such solvents can be DMSO and/or DMF, more preferably DMSO. In this case, the mixing temperature is preferably ranging between 1° C. and 80° C., more preferably between 10° C. and 70° C.

### 5^{th} Parameter: Effect of the Stirring Speed

The fifth parameter is the stirring speed that is applied during the process of step (c) of mixing the solution of KL into the water. Increasing the stirring speed has for effect to reduce the size of the nanoparticles. With preference, the stirring speed can be ranging between 300 rpm and 2500 rpm, more preferentially between 400 rpm and 2000 rpm. However, at stirring speed above 2500 rpm, preferably above 3000 rpm, more preferably above 3500 rpm, the addition and/or mixing of the KL solution into the antisolvent must be performed under an inert atmosphere (for instance, under argon and/or nitrogen atmosphere) to prevent the formation of foam. Indeed, foaming is caused by the combining effect of the inherent amphiphilic nature of the KL, entrapped air and higher stirring speed. Foaming can be detrimental to the final yield of KL nanoparticles that are obtained.

Advantageously, the one or more organic solvents are removed after the formation of the KL nanoparticles. To completely yield dried KL nanoparticles, a time that is ranging between 3 and 10 days is needed to remove the solvents. Such time is relatively long because it is needed to remove the organic solvent and the antisolvent without de-structuring the KL nanoparticles.

Solvents presenting high boiling points, such as DMSO (b.p.=189° C.), DMF (b.p. 153° C.) or 1,4-dioxane (b.p. 101° C.), can be removed from the KL nanoparticles using a dialysis process.

Solvents presenting lower boiling points, such as acetonitrile (b.p=82° C.), dichloromethane (b.p.=40° C.), tetrahydrofuran (b.p.=66° C.), ethyl acetate (b.p.=77° C.) or acetone (b.p.=56° C.) can be removed from the KL nanoparticles using rotary evaporator.

After complete removal of the solvents, a freeze-drying step can be undertaken to remove the antisolvents, i.e. water, from the KL nanoparticles. Preferentially, the freeze-drying step can be carried out at a temperature ranging between −50° C. and −100° C., more preferentially between −60° C. and −90° C., even more preferentially at −80° C. and/or during a time of at least 24 hours, preferentially of at least 3 days. The step of freeze-drying can also be advantageously carried out at a pressure ranging between 0.05 Pa and 0.20 Pa, more preferentially at a pressure ranging between 0.07 Pa and 0.15 Pa, and even more preferentially at 0.12 Pa.

### Characterization of the KL Nanoparticles of the Disclosure

For example, the average diameter size of the nanoparticles is ranging from 9 nm to 200 nm, or from 9 nm to 70 nm, or from 15 nm to 70 nm, as determined by imaging techniques, such as Scanning Electron Microscopy and/or Helium Ion Microscopy. SEM can be used for the nanoparticles presenting a bigger average diameter size while HIM is used for the nanoparticles presenting a smaller average diameter size. In general, a size of about 15 nm can be well-detected by SEM. As the KL nanoparticles generated by DMSO have in general a smaller average diameter size than the KL nanoparticles generated with THE, HIM experiments are carried out on the KL nanoparticles generated with DMSO.

For example, the Kraft lignin nanoparticles have an average diameter size ranging from 9 nm up to 14 nm as determined by Helium Ion Microscopy; or from 10 nm up to 13 nm.

For example, the Kraft lignin nanoparticles have an average diameter size ranging from 15 nm up to 200 nm as determined by Scanning Electron Microscopy; or from 15 nm up to 150 nm; or from 15 nm up to 100 nm; or from 15 nm up to 70 nm; or from 15 nm up to 65 nm; or from 15 nm up to 60 nm; or from 15 nm up to 55 nm; or from 15 nm up to 50 nm; or from 15 nm up to 45 nm; or from 15 nm up to 40 nm; or from 15 nm up to 35 nm.

For example, the average diameter size, as determined by Scanning Electron Microscopy is at least 15 nm, and at most 200 nm, preferably at most 150 nm, more preferably at most 100 nm, even more preferably at most 65 nm, most preferably at most 60 nm, even most preferably at most 50 nm.

For example, the average diameter size, as determined by Scanning Electron Microscopy is at least 20 nm, and at most 200 nm, preferably at most 150 nm, more preferably at most 100 nm, even more preferably at most 65 nm, most preferably at most 60 nm, even most preferably at most 50 nm.

For example, the average diameter size, as determined by Scanning Electron Microscopy is at least 25 nm, and at most 200 nm, preferably at most 150 nm, more preferably at most 100 nm, even more preferably at most 65 nm, most preferably at most 60 nm, even most preferably at most 50 nm.

When a solvent with high dissolving power is used to dissolve KL, the average diameter size of the KL nanoparticles obtained with the process according to the disclosure is ranging between 15 nm and 45 nm, preferably between 20 nm and 40 nm.

When a solvent with poor dissolving power is used to dissolve KL, the average diameter size of the KL nanoparticles obtained with the process according to the disclosure is ranging between 40 nm and 90 nm, preferably between 50 nm and 80 nm.

The KL nanoparticles can be re-dispersible in water.

With preference, the nanoparticle having an average diameter size ranging from 15 nm up to 60 nm has a transmittance taken at a wavelength of 600 nm ranging between 40% and 80% as determined by absorption analysis, preferably between 45% and 75%.

The KL nanoparticles have a fluffy aspect. For collecting them, it is preferable to use an electrostatic-free sample collector, because of the formation of high static charges on the nanoparticles.

The three-dimensional structure of the KL nanoparticle comprises at least two types of T-T stacking, as determined by UV-Visible analysis. There are three types of π-π stacking in organic compounds comprising aromatic structures, namely the H-shape corresponding to a sandwich-like structure, the T-shaped structure and the J-shaped structure corresponding to a parallel-displaced structure.

The KL nanoparticles have a glass transition temperature (T_{g}) of at least 150° C. as determined by Differential Scanning calorimetry. With preference, the KL nanoparticles have an additional T_{g} that is ranging between 110° C. and 130° C.

For example, said Kraft lignin nanoparticles have a transmittance taken at a wavelength of 600 nm ranging between 40% and 80% as determined by absorption analysis, preferably between 45% and 75%.

For example, said Kraft lignin nanoparticles have Young's modulus ranging between 1.0 GPa and 6.0 GPa as determined by atomic force microscopy, preferentially between 1.4 GPa and 5.1 GPa, more preferentially between 1.5 GPa and 5.0 GPa.

For example, said Kraft lignin nanoparticles have a polydispersity index ranging between 0.05 and 0.20 as determined by Dynamic Light Scattering method, preferably between 0.07 and 0.18, more preferably between 0.09 and 0.16, even more preferably between 0.11 and 0.14.

### Process for Coating a Substrate

The substrate can be a material selected from plastic, metal, steel, ceramic, wood, textile or silicate, preferably plastic. For example, plastic is Kapton (which is a polyimide film often used in spacecraft and/or on satellites), or ceramic is glass, or steel is stainless steel, or silicate is quartz. Examples of application can be the protection of an internal surface of a space shuttle, the external surface of a medical device, or the external surface of a textile (e.g., a fabric seat).

With preference, said substrate has a surface area of at least 50 cm², more preferably of at least 75 cm², even more preferably of at least 90 cm², most preferably of at least 250 cm², even most preferably of at least 500 cm², or at least 600 cm².

The surface-to-be-coated from the substrate must be cleaned before the coating. It is done for example by immersing the substrate in an alkaline soap solution, sonicating and then rinsing with deionized water followed by drying. For example, the alkaline soap solution can comprise a mixture of water, tetrasodium ethylenediaminetetraacetate (10-25 wt. %), ammonium xylene sulfonate (5-10 wt. %), benzenesulfonic acid 4-C10-13-sec-alkyl derivative (CAS 85536-14-7) with triethanolamine (5-10 wt. %) and sodium hydroxide (0.1-1 wt. %).

Instead of, or in addition to, an alkaline soap solution; the surface-to-be-coated of a substrate that is preferably a substrate presenting a high roughness can be cleaned with acetone and/or ethanol. A substrate presenting a high roughness is a substrate that is devoid of mirror finishing, namely a substrate presenting an RMS roughness of at least 800 nm, or of at least 850 nm, as determined by profilometry. The cleaning can also be performed by dry-cleaning the surface-to-be-coated with an inert gas before step (c), preferably nitrogen and/or argon. Treatment using a UV-ozonizer for 5 to 30 minutes can be also effective for cleaning the surface-to-be-coated.

The surface-to-be-coated is then activated by applying an aqueous mixture of one or more cationic polymers and ethanol. For example, the aqueous mixture of the one or more cationic polymers and ethanol comprises an amount of cationic polymer ranging between 5 wt. % and 30 wt. % of the total weight of said aqueous mixture of the one or more cationic polymers and ethanol, preferably between 10 wt. % and 25 wt. % or between 15 wt. % and 20 wt. %. For example, one cationic polymer is poly(ethylene imine).

Following the activation, the surface is dried, for example at a temperature ranging between 30° C. and 70° C., or between 40° C. and 60° C.

Then, the antimicrobial coating is applied. This can be done through one method selected from bar-coating, blade-coating, or slot die-coating, preferably through bar-coating. These methods are advantageous in comparison with the technique of dip-coating in that the resulting coating is more homogeneous and provides a controlled thickness of the coating, namely a thickness ranging between 0.5 μm and 5 μm as determined by profilometry, preferably ranging between 0.7 μm and 3 μm.

In a final step, the coated surface is cured, preferably during a period ranging between 1 hour and 12 hours, or between 2 hours and 10 hours. For example, the curing is performed at a temperature ranging between 60° C. and 120° C., or between 70° C. and 110° C.

### Test and Determination Methods

### Scanning Electron Microscopy (SEM)

SEM images were obtained using Focus Ion Beam (FIB) scanning electronic microscope (model: Helios Nanolab 650), operating at a voltage of 2-30 Kv and current of 13 to 100 pA. Before the SEM analysis, the samples were dried overnight in the open air. Measurements were done in both feel free mode and immersion mode. To confirm the exact size of nanoparticles, SEM analyses are done without any metal coating. SEM images were analysed using ImageJ software.

### Helium Ion Microscopy (HIM)

HIM images were obtained using Helium Ion Microscope (HIM: ZEISS ORION NanoFab) from Carl Zeiss Microscopy GmbH. All the lignin dispersions in DMSO were diluted 100× to visualize a primary particle effectively. The samples were prepared by drop-casting 0.02 mL of lignin dilution onto a silicon wafer and allowing it to dry overnight under a fume hood. The samples were characterized without any conductive coatings. The size and polydispersity of Lignin nanoparticles were analysed using ImageJ (Version 1.52) and MountainsSPIP 8 software.

As the nanoparticles fabricated using THF are bigger than the nanoparticles fabricated using DMSO, SEM analysis was sufficient to visualize the bigger KL nanoparticles, while it was necessary to perform HIM analysis to visualize the smaller nanoparticles. From these two imaging techniques, the shape and the size of the nanoparticles were determined.

### Differential Scanning Calorimetry (DSC)

Glass transition temperature (T_{g}) of the lignin samples was determined using a DSC instrument (DSC 3+, METTLER TOLEDO GmbH) under a nitrogen atmosphere. Before analysis, lignin was dried overnight under a vacuum at 60° C. During each measurement, approximately 10 mg of dry lignin was used. The samples were heated from room temperature to 120° C. at a heating rate of 10° C./min (first measurement cycle), isothermal for 5 minutes, cooled to 0° C. at a cooling rate of 10° C./min, isothermal for 5 minutes, then reheated to 200° C. at a heating rate of 10° C./min (second measurement cycle). T_{g} was measured from the second measurement cycle.

### Ultra-Violet (UV)—Visible Analysis

π-π stacking of lignin nanoparticles was confirmed with the help of UV-Visible spectroscopy. The multifunctional monochromator-based microplate reader, Tecan infinite M1000Pro, has been used to determine the UV-Visible spectrum. To perform the analysis, dried KL nanoparticles were re-dispersed in MilliQ water (0.025 mg/mL). Samples were placed in the Greiner 96 Flat Bottom Transparent Polystyrol plate. Absorbances were measured from 230 nm to 800 nm wavelengths. 286 scans and 25 flashes were used at 25° C. for each measurement.

### Absorption Analysis

PerkinElmer (LAMBDA 1050+UV/Vis/NIR) spectrophotometers were used to measure the % transmittance of Lignin Nanodispersion. 3 mL of 20 mg/mL (initial lignin concentration) of each nanodispersion and the deionized water were placed in an acrylic cuvette before the measurement. Double beam arrangements were used to perform the measurement. The percentage of transmittances was noted at 600 nm of wavelength.

### Dynamic Light Scattering (DLS)

Hydrodynamic particle size and distribution (by determining the polydispersity index PDI) of the KL nanoparticles were measured using a Malvern Zetasizer Nano-ZS90 instrument (UK). Before analysis, samples were diluted 100 times in water. The refractive index of polystyrene (1.58654 at 632.8 nm) was used as an internal standard value. Measurements were done with a glass cuvette at 25° C. To confirm the reproducibility, three measurements were carried out in each sample. After each analysis, the glass cuvette was washed with MillliQ water and dried using argon. As a hydration layer is formed around the sample during the measurements of the size, the size obtained by DLS is bigger than the size obtained by using the scanning electron microscope.

### Atomic Force Microscope (AFM)

The topography and nanomechanical properties of the samples were thus investigated using an MFP3D Infinity AFM (Asylum Research/Oxford Instruments, Santa Barbara, CA) working in a bimodal AM-FM (Amplitude Modulation-Frequency Modulation) configuration. The samples were prepared by drop-casting the raw lignin, KLNP1 (DMSO system), and KLNP2 (THF system) (100× diluted and dispersed in water) on a silicon wafer and drying it overnight under a fume hood.

In the bimodal AM-FM mode, the nanoscale tip attached to the cantilever is simultaneously excited with two eigenmodes (two different oscillation motions of the cantilever). As the tip approaches the sample surface, the oscillation of the tip is reduced by its interaction. A feedback loop acting on the piezo scanner (Z direction) keeps the amplitude (A_{1, set} (112 nm) of the 1^{st} eigenmode (c. 265 KHz) of the cantilever constant to obtain the topography of the sample. The amplitude A_{1, free} away from the surface, was set at 160 nm. The 2^{nd} eigenmode (1.52 MHZ) was simultaneously driven at a smaller amplitude A₂ (500 pm) and assisted in detecting the frequency shift (Δf₂) via a 90° Phase Lock Loop (φ₁, PLL). The frequency feedback loop maintains the 2^{nd} eigenmode on resonance by a frequency shift (Δf₂) and this is caused due to the change in nanoparticle stiffness. Before calibration, the tip was scanned in contact mode over a TiO₂ surface to round up its apex. The increased tip curvature radius ensured a more stable operation in Elastic Modulus (EM) characterization.

### X-Ray Photoelectron Spectroscopy (XPS)

XPS spectra were obtained using an X-ray photoelectron spectroscopy (Kratos Axis-Ultra DLD) with an X-ray beam generated by an Al Kα source with the following parameters: E=1486.6 eV; Power: 50 W; Analysed area: 700×300 μm². It leads to a depth analysis lower than 10 nm. The analyser parameters are energy resolution of 1.5 eV for survey scans and 0.7 eV for narrow scans; photoelectron emission take-off angle: 0° to the surface normal. The energy calibration is done on C 1s peak @ 285.0 eV. Charge compensation is enabled to limit charging effects during analysis. The data treatment is performed using the Casa XPS software.

### Time-of-Flight Secondary Ion Mass Spectrometry (ToF-SIMS)

The Time-of-Flight Secondary Ion Mass Spectrometry (TOF-SIMS) experiments were performed with a commercial TOF-SIMS V (IonTOF GmbH, Münster, Germany) instrument. The analyses were carried out using a pulsed bismuth liquid metal ion gun (LMIG, Bi³⁺ ions, 25 keV) delivering a 0.40 pA target current. The analyses were carried out using a primary ion dose density maintained to 1011 ions/cm². The analysed area was 500 μmm×500 μm. The data acquisition and processing software were Surface Lab 7.0 (ION-TOF GmbH, Münster, Germany). The data were obtained in both negative and positive ion modes and the secondary ion mass spectra were calibrated using Cn carbon clusters and CₓH_{y}⁺species, respectively.

### Log Reduction

The antibacterial activity of coatings was evaluated following the International Standard ISO 22196:2011. The ISO test method is based on the comparison of the number of viable bacteria recovered from samples/surfaces coated (treated specimens) and the number of viable bacteria recovered from control (untreated specimens) after a defined contact time (24 h) and in specific conditions (30° C., >90% RH, CO₂ 5000 ppm). The reduction of viable bacteria is calculated and represented as log 10-reduction. This value can be used to characterize the effectiveness of an antibacterial agent/surface.

The ISO 22196 was performed with slight modifications. S. aureus ATCC 6538P (Culti-Loop R4609002, Thermo Fisher) and E. coli ATCC 8739 (Culti-Loop R4607085, Thermo Fisher) are used as test micro-organisms. The test inoculums are prepared by transferring bacteria from Culti-Loops onto nutrient agar medium (10 g/l peptone M66, Merck 1.07043.1000; 5 g/I meat extract, Merck 1.03979.0500; 5 g/l sodium chloride, VWR 27810.295; 16 g/l agar bacteriological, Oxoid LP0011; q.s. Milli-Q water, Millipore) and incubated at 37° C. for 16 h to 24 h.

After two successive subcultures onto nutrient agar at 37° C. 16 h to 24 h, bacteria are collected from the agar medium surface: one full loop of the colonies is transferred into 10 ml of 1/500 of nutrient broth (500-fold dilution of nutrient broth in Milli-Q water, nutrient broth: 10 g/l peptone M66, Merck 1.07043.1000; 3 g/I meat extract, Merck 1.03979.0500; 5 g/l sodium chloride, VWR 27810.295; q.s. Milli-Q water, Millipore). The bacterial suspensions obtained are diluted with 1/500 of nutrient broth comprising 0.3 wt. % of agar (3 g/l agar bacteriological, Oxoid LP0011) based on the total weight of the nutrient broth to obtain a concentration that is between 2.5×10⁵ cells/ml and 10×10⁵ cells/ml.

The treated (n=3) and non-treated specimens (n=3) are prepared in a 50 mm×50 mm square dimensions. The treated surfaces to be tested are the exposed outer and are inoculated with 400 μl of the test inoculum (S. aureus or E. coli). To enlarge the contact area of the coatings with the inoculum, the 400 μl of test inoculum is covered with a sterile plastic film (40 mm×40 mm, film cut from stomacher bags, VWR 129-0729). The specimens (treated and non-treated) are stored in a separate sterile petri dish and are incubated at 30° C. for 24 h (>90% RH, 5000 ppm CO₂). After 24 h contact time, the specimens are transferred in a (VWR 129-0729) and the inoculated suspension is washed out by adding 10 ml of Soybean casein digest broth with lecithin and polyoxyethylene sorbitan monooleate (SCDLP broth: 30 g/l Tryptone Soya Broth, Oxoid CM0129; 1 g/l lecithin Sigma-Aldrich 61755; 7 g/l Tween 80 Sigma-Aldrich P1754; q.s. Milli-Q water). Then, tenfold serial dilutions of the SCDLP broth recovered from the stomacher bag specimens were made in Phosphate buffered saline (Dulbecco's Phosphate Buffered Saline, Thermo Fisher 14190-094). 1 ml of SCDPL broth and/or tenfold dilutions were placed in separate sterile Petri dishes (performed in duplicate). 15 ml of Plate Count Agar (22.5 g/l, Merck VWR 1.05463.0500) are poured into each petri dish. Petri dishes were incubated at 37° C. for 24 h. The number of colonies on each Petri dish was recorded and used to determine the number of viable bacteria.

The value of antibacterial activity was calculated by subtracting the logarithmic value of the number of viable bacteria of the treated specimen (per cm²) from the logarithmic value of the viable bacteria of the untreated specimen (per cm²) after inoculation and incubation:

$$log 10 - reduction = log 10 ( geometric mean of the number of viable bacteria recovered from untreated specimens after 24 h / of the number of viable bacteria recovered from treated specimens after 24 h ) .$$

### Profilometry Experiments

The analyses are carried out on a P17 KLA tencor contact profilometer. Stylet's radius of curvature is 2 μm/angle is 60°. Force applied to the tip is 2 mg. The scanning speed is 50 μm·s⁻¹. The scanned area is 500 μm×500 μm. Resolution in x is 0.25 μm. Resolution in y is 3 μm. The frequency used is 200 Hz. The results of the characterization obtained on the samples are processed using the Apex 3D Basic software. The roughness measurements follow the ISO25178 (3D) and ISO4287 (2D) standards. For the 2D measurements, a Gaussian filter and a cut-off wavelength of 25 μm are used.

The profilometry experiments can also provide the determination of the thickness of the coating on the sample. The tip of plastic tweezers allows for making a groove in the coating, whose depth is then measured using the Apex 3D Basic software.

### ³¹P Nuclear Magnetic Resonance (NMR) Spectroscopy Analysis

The ethanol soluble fraction of the lignin was extracted as followed. 1 g of lignin was dissolved in 1L of ethanol using an ultrasonic bath for 20 min. The solutions were left to rest for 12h for the insoluble part of lignin to sediment. The supernatants of the lignin solutions were collected and evaporated by rotavapor. The dried ethanol soluble fraction of the lignin was then extracted from the balloon using water. After filtration of filter paper, the ethanol soluble fraction of the lignin was dried in an oven at 50° C. overnight. The resulting powder was characterized by NMR.

The ³¹P nuclear magnetic resonance (NMR) spectroscopy analysis was performed using an AVANCE III HD spectrometer (Bruker, Fällanden, Switzerland) equipped with a 5 mm BBO-probe, operating at a proton frequency of 600 MHz. The protocol was adapted following the work reported by A. Adjaoud et al.². 30 mg of lignin were dissolved in 700 μL of a solvent mixture containing deuterated chloroform (CDCl₃) and anhydrous pyridine in a 1/1.6 (v/v) ratio. This solvent mixture served also for the preparation of the relaxation agent (RA) chromium (III) acetylacetonate (14 μmol mL⁻¹) and the internal standard (IS) endo-N-hydroxy-5-norbornene-2,3-dicarboximide (108 μmol mL-1) solutions. The derivatization reaction performed prior to the ³¹P NMR analysis, namely the phosphitylation, was performed by adding to the mixture of lignin 100 μL of the RA stock solution, 100 μL of the IS stock solution, and 100 μL of the phosphitylation reagent 2-chloro4,4,5,5-tetramethyl-1,3,2-dioxaphospholane (TMDP). All ³¹P NMR spectra were calibrated on the IS derivatized peak (sharp signal at δ=152.0 ppm).

### Gel Permeation Chromatography (GPC)

Gel permeation chromatography (GPC) analyses were performed on a 1200 Infinity gel permeation chromatograph (GPC, Agilent Technologies) equipped with an integrated IR detector, a PL PolarGel-M column and a PL PolarGel-M guard column (Agilent Technologies). Lignin samples were dissolved at a mass concentration of 3 mg·mL 1 in a 0.1 M solution of Li(CF₃SO₂)₂N in dimethyl formamide (DMF). The resulting lignin solution was filtered on PTFE 0.2 mm filters. 200 μL of filtered solution were injected into the PolarGel-M column (7.5*300 mm). The eluent was a 0.1 M solution of Li(CF₃SO₂)₂N in DMF at a flow rate of 1 mL·min⁻¹. The column was maintained at 50° C. during the analysis. Polymethylmethacrylate standards (EasiVial PMMA, Agilent Technologies, Mp=550-1568000 g mol⁻¹) were used to perform calibration. The number average molecular weight (Mₙ) and the weight average molecular weight (M_{w}) were obtained using the resulting calibration curve. The polydispersity index (PDI) was calculated using the ratio M_{w}/Mₙ.

### Examples

The embodiments of the present disclosure will be better understood by looking at the example below.

UPM Finland supplied Kraft Lignin (BIOPIVA 190) as a brown powder. The following elements were determined for this Kraft lignin by inductively coupled plasma spectroscopy (ICP-MS) in accordance with the standard NF EN ISO 21663: (C 62.5, H 6.08, S 1.96, N<0.1) % with 95% of dry matter. Additional characterization of the Kraft Lignin has been performed by 31P nuclear magnetic resonance (NMR) spectroscopy analysis and by gel permeation chromatography (GPC) analyses. The results of Kraft lignin 31P NMR characterization gave a total content of hydroxyl groups of 8 mmol·g⁻¹. It gives 5.0 mmol·g⁻¹ for phenolic groups, 1.8 mmol·g⁻¹ for aliphatic groups and 1.0 mmol·g⁻¹ for carboxylic acid groups. It gives an aliphatic group/phenolic group ratio of 0.32. The results of lignin GPC characterization provide Mₙ and M_{w} values of Kraft lignin of respectively 460 and 1368 g·mol⁻¹, as well as a PDI of 2.9.

HPLC grade tetrahydrofuran (THF) and anhydrous dimethyl sulfoxide (DMSO) were purchased from Sigma Aldrich.

MilliQ water (0.2 μm PES high flux capsule filter; 18.2 M′Ω·cm at 23° C.) was used as it is from the laboratory.

PVA powder (CAS 9002-89-5), PAA powder (CAS 9003 Jan. 4), chitosan (CAS 9012-76-4), citric acid (CAS 77-92-9), glyoxal 40 wt. % in water (CAS 107-22-2) and boric acid (CAS 10043-35-3) have been purchased from Sigma Aldrich.

The alkaline soap solution MICRO-90® Concentrated Cleaning Solution was purchased from Cole-Parmer.

Antimicrobial coating C1 (Nitropep) and C2 (SCS MicroResist®) were respectively purchased from Nitropep and Specialty Coating Systems.

### Preparation of the Lignin Nanoparticles

→ Synthesis of KL nanoparticles with a diameter size ranging between 9 nm and 45 nm

1 g of KL (BioPiva) was dissolved in 50 mL of DMSO. The mixture was stirred at room temperature (25° C.) until a clear solution was obtained. Then the solution was added to a 1 L water reservoir, which was stirred at a speed of 1000 rpm at room temperature (25° C.). The temperature of the water reservoir was kept at 25° C. A glass syringe (50 mL) with a sharp needle (1.00*60 mm) was utilized for the addition of lignin solution into the water reservoir. The mixture was kept stirring for 1 minute. The KL nanoparticles formation took place immediately after the complete addition of KL solution. Then DMSO was removed using dialysis at room temperature for 4 days. After that, water dispersed were frozen at −80° C. overnight using a freezer. Finally, the frozen KL nanoparticles were freeze-dried at 0.001 mbar and −110° C. for 4 days using freeze-drier (Christ: Alpha 3-4 LSC basic). Fluffy dried powder samples were stored in glass vials. The final yield of the sample was 90%.

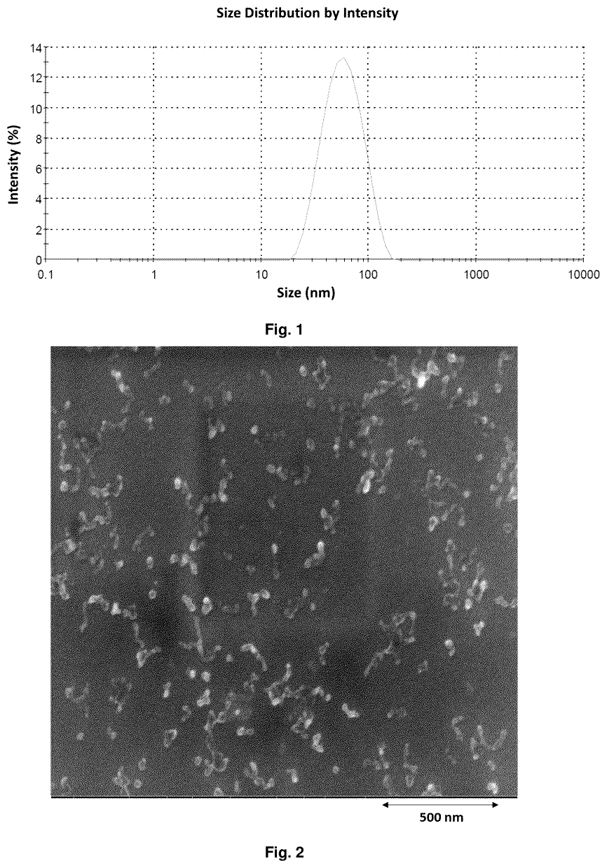

The DLS analysis, indicated in FIG. 1, confirms that the hydrodynamic radius of the KL nanoparticles is 55 nm with a narrow polydispersity index of 0.18.

The SEM analysis, shown in FIG. 2, confirmed that the average diameter size of the dried KL nanoparticles is 15 nm. Most of the nanoparticles, namely between 80% and 90% of the nanoparticles, present an average diameter size which is 15 nm, also confirming the narrow polydispersity index of 0.18.

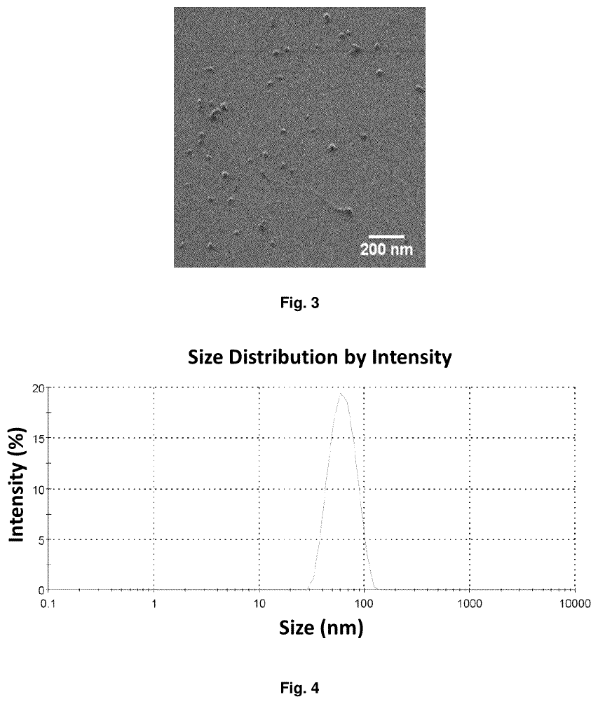

The HIM analysis, shown in FIG. 3, also confirmed that the average diameter size of the dried KL nanoparticles is about 15 nm (more specifically 17 nm, with a standard deviation of 8 nm). HIM analysis is therefore a confirmation that KL nanoparticles having an average diameter size as low as 9 nm or 10 nm can be obtained. The HIM analysis further confirms the sphericity of the KL nanoparticles fabricated using the DMSO system.
→ Synthesis of KL nanoparticles with a diameter size ranging between 35 nm and 70 nm

1 g of KL (BioPiva) was dissolved in 50 ml of THF. The mixture was stirred at room temperature (25° C.) until a clear solution was obtained. Then the solution was added to 1 L of a cooled water reservoir, which was stirred at a speed of 1000 rpm. The temperature of the water reservoir was kept at 10° C. A glass syringe (50 mL) with a sharp needle (1.00*60 mm) was utilized for the addition of lignin solution into the water reservoir. The mixture was kept stirring for 1 minute. The KL nanoparticles formation took place immediately after the complete addition of KL solution. Particle size was characterized using dynamic light scattering (DLS). Then THF was removed using a rotary evaporator. After that, water dispersed KL nanoparticles were frozen at −80° C. for overnight using a freezer. Finally, the frozen LNPs were freeze-dried at 0.001 mbar and −110° C. for 3 days using freeze-drier (Christ: Alpha 3-4 LSC basic). Fluffy dried powder samples were stored in glass vials. The final yield of the sample was 80%.

FIG. 4 indicates the DLS spectrum of the KL nanoparticles presenting a hydrodynamic radius of 80 nm with a narrow PDI of 0.15.

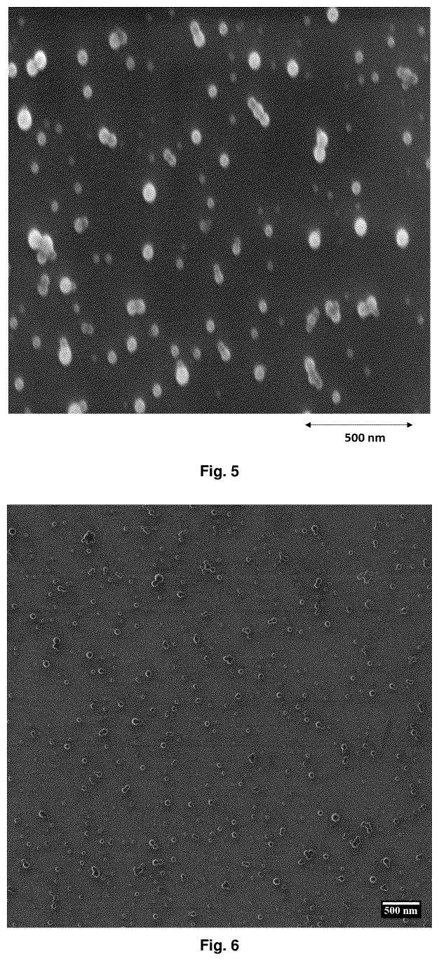

The SEM image is given in FIG. 5 and confirms that the average diameter size of the dried KL nanoparticles is ranging between 50 nm and 70 nm, and is more particularly 60 nm. A refinement of this size has been done by determining the size with HIM, as this was the case for the KL nanoparticles obtained from the DMSO system. The HIM analysis, presented in FIG. 6, thus shows that the average diameter size of the dried KL nanoparticles is ranging between 35 nm and 65 nm, and is more particularly 43 nm.

The removal of THF, using roto-evaporation, is easier in comparison with the synthesis of the KL nanoparticles in DMSO, where DMSO is removed using dialysis. However, the use of DMSO is interesting since it is more environment-friendly than THF.

### Additional Characterization of the KL Nanoparticles by Absorption Analysis

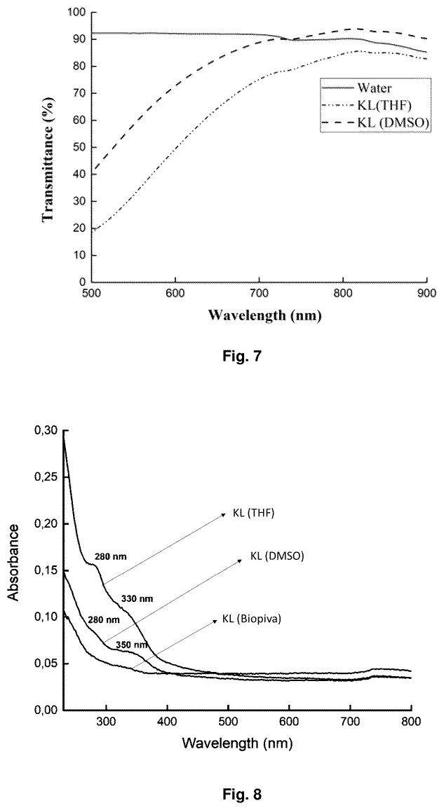

The KL nanoparticles, dispersed in water, which have an average diameter size below 60 nm, do not coalesce together nor form aggregates. FIG. 7 shows the transmittance of incident light having a wavelength ranging between 500 nm and 900 nm measured on the KL nanoparticles. This analysis was performed at an initial lignin concentration of 20 mg/mL. Table 1 indicates the obtained results at 600 nm.

TABLE 1
Transmittance measurements

| | | transmittance |
|---|---|---|
| Sample | Size^{a} | at 600 nm^{b} |
| water | n.a.^{c} | 92% |
| KL (THF) | 60 nm | 49% |
| KL (DMSO) | 15 nm | 72% |

^{a}as determined by Scanning Electron Microscopy
^{b}as determined by Absorption analysis
^{c}non applicable

### Additional Characterization of the KL Nanoparticles by UV

As KL is an organic compound comprising aromatic structures, UV-Visible analyses have revealed that there is the presence of two different kinds of π-π stacking in the KL nanofabrication. FIG. 8 shows that the UV visible spectrum of the KL nanoparticles fabricated in THF and DMSO (in comparison with the spectrum of the KL) and the absorbance at 280 nm indicates the presence of J aggregates, namely parallel-displaced compounds. Such absorbance in lignin nanoparticles has already been reported in the study entitled “Preparation and characterization of lignin nanoparticles: evaluation of their potential as antioxidants and UV protectants”, from Rao Yearla S. et al. (J. Exp. Nanosci., 2016, 11 (4), 289-302).

A second type of π-π stacking has been observed by UV-Visible analysis, at a wavelength ranging between 315 nm and 365 nm, more specifically at 330 nm for the KL nanoparticles fabricated using THF and at 350 nm for the KL nanoparticles fabricated using DMSO. Since the H aggregates reflect the repulsive forces caused by a symmetric cloud of molecules, it is assumed that the absorbance at 350 nm is due to the H aggregates occurring when DMSO is used to dissolve KL. The absorbance at 330 nm is rather due to the T-shaped structure occurring when THF has been employed to fabricate the KL nanoparticles, since it reflects the asymmetricity in the formation of KL nanoparticles, probably due to a lack of diffusion in comparison with the system where DMSO is used.

### Additional Characterization of the KL Nanoparticles by DSC

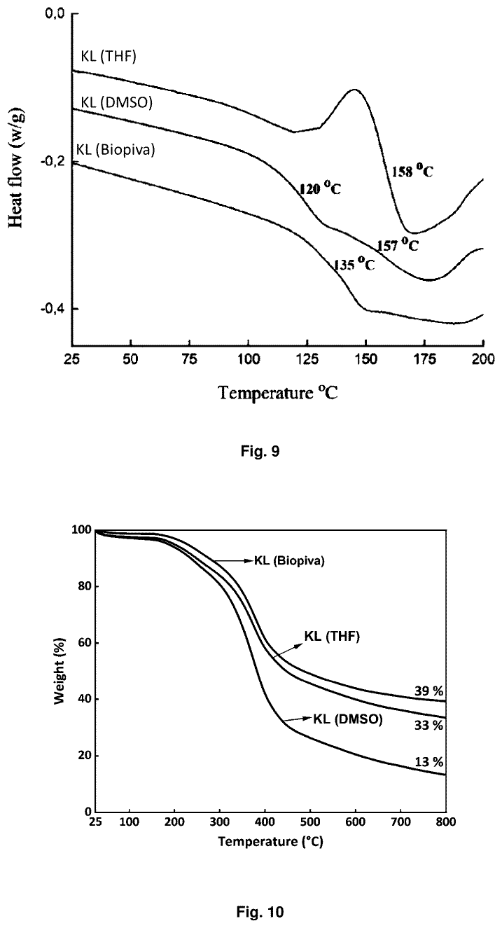

FIG. 9 shows the DSC curve of the KL nanoparticles of the disclosure in comparison with KL and reveals that the KL nanoparticles have a glass transition temperature (T_{g}) of 157° C. and 158° C. for the KL nanoparticles fabricated respectively in DMSO and THF. This T_{g} is higher than the T_{g} for the KL. As an elevated T_{g} is an indication that more energy is required to break the physical interaction between two components, it is remarkable that the stability of the KL nanoparticles of the disclosure is considerably enhanced.

Moreover, for the KL nanoparticles fabricated in THF, the exothermic hump is the evidence of the energy release while de-structuring the self-assembly of the KL nanoparticles and the hump itself corroborates the assumption that the π-π stacking, determined thanks to the UV-Visible analysis, is of the T-shape.

For the KL nanoparticles fabricated in DMSO, a second T_{g} has been observed at 120° C. The presence of two glass transition temperatures indicates that the KL nanoparticle comprises two segmental arrangements. T_{g} at 120° C. reflects the π-π stacking of the H-type, since this kind of π-π stacking involves repulsive forces and thus demands less energy to break down. This second T_{g} corresponds to the breakdown of the polymer chains that constitute the KL in the KL nanoparticles.

### Additional Characterization of the KL Nanoparticles by TGA

FIG. 10 shows the TGA analysis of the KL nanoparticles of the disclosure in comparison with the KL. As displayed, the degradation of KL starts from 220° C. 39% char yield of KL is observed. The KL nanoparticles fabricated in DMSO and THF have a similar curve, although more stable than KL, with respectively 13% char yield and 33% char yield. % char yield is equivalent to the residual weight % of the material on which the TGA analysis is carried out. The smaller nanoparticles have a higher surface area and high thermal conductivity, which catalyse their degradation.

### Additional Characterization of the KL Nanoparticles by AFM

The bimodal AM-FM analyses allow to simultaneously obtain topography and elastic modulus (Young's modulus) images.

The bimodal AM-FM mode provides the quantitative mapping of the nanomechanical properties of a surface, as indicated in the study by Kocun M., et al. entitled “Fast, High Resolution, and Wide Modulus Range Nanomechanical Mapping with Bimodal Tapping Mode” (ACS Nano, 2017, 11 (10), 10097-10105).

The cantilever stiffness of the AFM tip (AC160TS, Olympus, Japan), k₁ (28.9 N/m), and k₂ (952 N/m), at its 1^{st} (f₁) and 2^{nd} (f₂) eigenmodes, as well as the inverse optical sensitivity, are calibrated using the Sadler non-contact method before the measurements. The quality factor Q₁ (406) is extracted during the amplitude tune of A_{1, free} (160 nm) of the 1^{st} eigenmode.

The Hertz model for contact mechanics was applied for the analytical calculation of modulus mechanics (see studies of Benaglia S. et al., entitled “Fast and high-resolution mapping of elastic properties of biomolecules and polymers with bimodal AFM” (Nat. Protoc., 2018, 13 (12), 2890-2907) and of Labuda A. et al., entitled “Generalized Hertz model for bimodal nanomechanical mapping” (Beilstein J. Nanotechnol., 2016, 7, 970-982). The calibrated cantilever parameters (k₁, k₂, f₁, f₂ and Q₁), combined with readings collected during the analysis (A₁, φ₁ and Δf₂), allow the calculation of the indentation depth δ (Eq. 1) of the tip on the surface and the effective storage modulus E_{eff} (Eq. 2).

In the case of flat punch tip:

$$δ = \frac{3}{4} \frac{{k}_{1}}{{Q}_{1}} {A}_{1 , free} cos {φ}_{1} \frac{{f}_{2}}{2 {k}_{2} Δ {f}_{2}} \qquad Eq . 1$$

$${E}_{eff} = \sqrt{\frac{2}{3}} \frac{π}{R} {( \frac{{k}_{1}}{{Q}_{1}} \frac{{A}_{1 , free}}{{A}_{1 , set}} cos {φ}_{1} )}^{- \frac{1}{2}} {( 2 {k}_{2} \frac{Δ {f}_{2}}{{f}_{2}} )}^{\frac{3}{2}} \qquad Eq . 2$$

From equation 2, the AFM tip radius (R) is the only free parameter to be determined and modelized as a flat punch. This parameter is determined by analysing a modulus reference sample (polystyrene/polycaprolactone). The EM of the polystyrene phase is 2.7 GPa and then the tip radius was extracted.

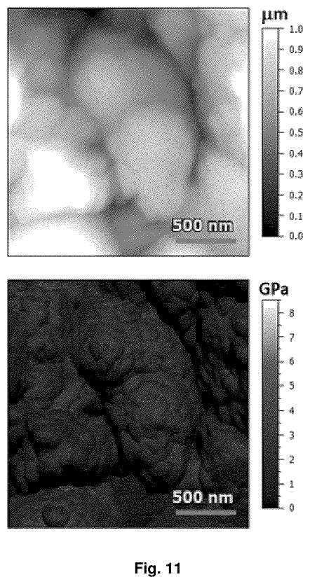

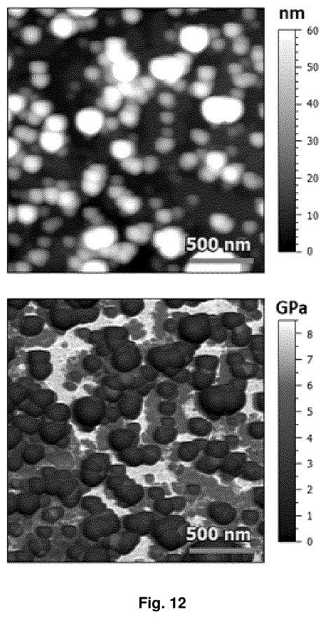

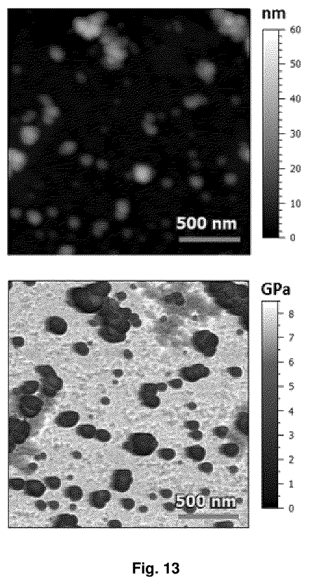

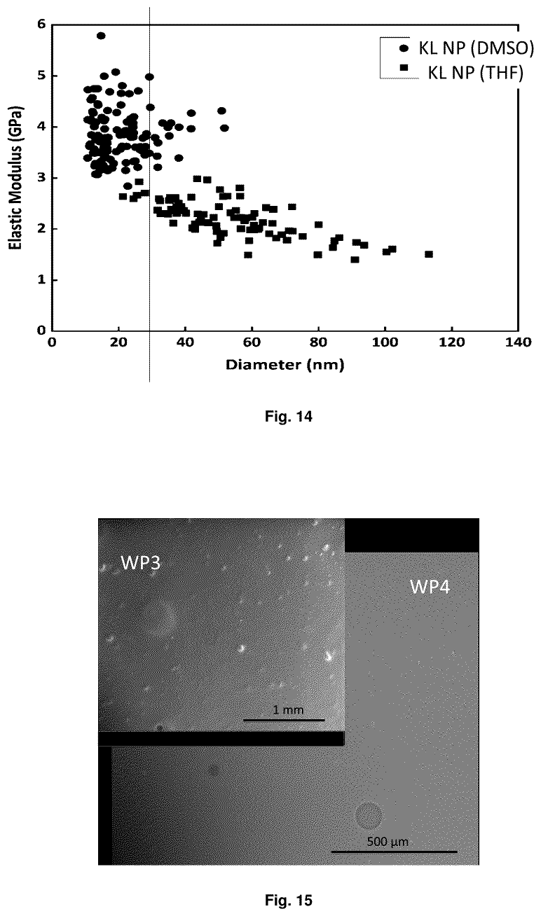

The indentation depth (δ: 800 pm) contributed to measure the sample topography. The effective storage modulus was calculated using the above-measured variables. The nanoparticles are individually segmented by a watershed mode in MountainSPIP 8 software (Digisurf, France). The mask obtained is then applied to the EM image to obtain maximum height (assumed to be the diameter) and the corresponding average EM of the same particle, as shown in FIG. 11 (for the raw KL), FIG. 12 (for the KL nanoparticles generated using the THF system) and FIG. 13 (for the KL nanoparticles generated using the DMSO system). FIG. 14 shows the KL nanoparticles size distribution correlated to Young's modulus derived from Atomic Force Microscopy experiments.

Therefore, it was determined that said KL nanoparticle has Young's modulus ranging between 1.0 GPa and 6.0 GPa as determined by Atomic Force Microscopy, preferentially between 1.4 GPa and 5.1 GPa, more preferentially between 1.5 GPa and 5.0 GPa.

For example, the KL nanoparticles generated using the THF system have Young's modulus ranging between 1.0 GPa and 3.0 GPa as determined by Atomic Force Microscopy, preferentially between 1.4 GPa and 2.9 GPa, more preferentially between 1.5 GPa and 2.8 GPa, even more preferentially between 1.6 GPa and 2.7 GPa.

For example, the KL nanoparticles generated using the DMSO system have Young's modulus ranging between 2.7 GPa and 6.0 GPa, preferentially between 2.8 GPa and 5.1 GPa, more preferentially between 2.9 GPa and 5.0 GPa, even more preferentially between 3.0 GPa and 4.9 GPa.

### Preparation of an Antimicrobial Coatings

Preparation of aqueous suspension of KLNPs.

Aqueous suspension of KL nanoparticles comprising 1 wt. % of KL nanoparticles based on the total weight of each aqueous suspension of KL nanoparticles is prepared. The KL nanoparticles have an average diameter size of 60 nm as determined by SEM image (cfr FIG. 5) or an average diameter size of 43 nm as determined by HIM image (cfr FIG. 6). This means that the KL nanoparticles were synthesized in THF.
Preparation of the WP3 coating

A chitosan solution is prepared by adding 1 g of low molecular weight (i.e., ranging between 50000 Da and 190000 Da) chitosan (Sigma Aldrich) into a flask with 100 ml of water under stirring. The mixture is progressively heated up to 80° C., and droplets of citric acid (50% w/w) are added until the powdered chitosan is dissolved. Subsequently, the solution is distilled in the rotavap at 50° C. with 125 rpm during 90 minutes until a concentration of 5.2 wt. % of chitosan based on the total weight of the aqueous solution of chitosan is reached. Evaporation starts with a pressure of 80 mbar (20 min), followed by 70 mbar (20 min), 60 mbar (20 min) and finally 50 mbar (30 min).

The solution is finally centrifuged at 10,000*g for 10 minutes, to precipitate any undissolved chitosan or debris.

An aqueous solution of PVA in water is prepared (1 g in 10 g of water or 1 g in 10 ml of water), the solution having a concentration of 10 wt. % based on the total weight of the aqueous solution of PVA. The PVA solution is prepared by soaking the solid PVA in DIW for one hour, and then placing the mixture under an overhead stirrer while heating up to 85° C. until the solution becomes homogenous.

The coating WP3 is prepared by weighing 10 g of the aqueous solution of PVA at 10 wt. % and adding the 0.77 g of the chitosan solution having a concentration of 5.2 wt. %. This mixture is stirred with an impeller until a homogenous solution is obtained. Afterwards, 6.2 g of Kraft lignin nanoparticle solution (at a concentration of 0.5 wt. % of KLNP based on the total weight of the KLNP aqueous solution) is added dropwise under strong stirring. Finally, 3.5 g of an aqueous solution of crosslinking agent, boric acid, at a concentration of 5.0 wt. % of boric acid based on the total weight of the aqueous solution of the crosslinking agent, is added dropwise, and the coating is covered and stored overnight to allow the removal of trapped air bubbles.

As 6.2 g of KLNP solution having a concentration of 0.5 wt. % of KLNP based on the total weight of the KLNP solution has been used, the final concentration of KLNP in the coating amounts to 0.15 wt. % based on the total weight of the WP3 coating.
Preparation of the WP4 coating

The following table 2 summarizes the concentration of the final coating of the WP4 coating

TABLE 2
Composition of the WP4 coating

| | | | | | | graphene |
|---|---|---|---|---|---|---|
| | PVA | KLNP | chitosan | glyoxal | PAA | oxide |
| | (wt. %) | (wt. %) | (wt. %) | (wt. %) | (wt. %) | (wt. %) |
| #1 | 69.25 | 0.75 | 20 | 10 | 0 | 0 |
| #2 | 54.25 | 0.75 | 20 | 10 | 15 | 0 |
| #3 | 64 | 6.5 | 12.8 | 6.5 | 9.6 | 0.6 |

The coating WP4 #1 is prepared by adding dropwise under stirring a KL nanoparticle solution into an aqueous solution of PVA. Then an aqueous chitosan solution is added. Mixing was performed until all the jelly has been dissolved. Finally, an aqueous solution of crosslinking agent, glyoxal, is added dropwise, and the coating is covered and stored overnight to allow the removal of trapped air bubbles.

For the coating WP4 #2, a PAA solution was added to the mixture of KL nanoparticles and PVA, before adding the aqueous chitosan solution. Said PAA solution is prepared as follows: 50 g of polyacrylic acid (PAA) powder (stored in the fridge between 2 and 8° C.) were weighed and transferred into a lab bottle. Then, 50 g of water was added to the bottle and closed tight. The bottle was placed in an ultrasound bath for 30 minutes for a complete dissolution of the PAA.

For the coating of WP4 #3, the protocol performed for making WP4 #2 has been followed, with an extra step, the addition of a graphene oxide solution right after the addition of the PAA solution before adding the aqueous chitosan solution

### Coating of Substrates

### Procedure for Substrate Preparation

The preparation of the substrate (in Kapton and/or in stainless steel AISI 304) consists of the removal of debris and impurities from the surface of the uncoated sample.

For substrates of 100 cm², the cleaning step is carried out by immerging the samples for ten minutes in an ultrasonic bath with ethanol 99%, subsequently in isopropyl alcohol, and finally in deionized water (DIW). After drying, the surface-to-be-coated is exposed to UV light in an ozone environment for 15 minutes and wrapped in aluminium foil for storage.

For substrates of 625 cm² (upscaled substrates), the cleaning step is carried out by preparing an ultrasonic bath to 70° C. with enough fresh DIW. Then a MICRO-90® Concentrated Cleaning Solution was diluted from the bottle to 5% volume and put in a container with the sample to be cleaned. It was then sonicated for 20 minutes and afterwards rinsed with DIW. The samples were dried and stored for subsequent cleaning. Upscaled stainless-steel samples can be further cleaned with the CO₂ snow jet while upscaled Kapton samples can be further cleaned with plasma treatment.

Before use, the substrates were dry-cleaned with inert gas, such as nitrogen.

Once cleaned, the substrate was placed on the coater board. A cationic polymer solution, in this case poly(ethylene imine) (PEI) solution made from 5 g of PEI in 10 g of water and 100 g of ethanol, was applied on the surface-to-be-coated of the substrate. The sample was then dried in an oven at a temperature of 50° C. Then the surface-to-be-coated of the substrate is coated with the WP4 or WP3 solution. The WP4 or WP3 solution were applied on the surface-to-be-coated using a bar coater. The bar coater is a Large KHC kit (article ref. KHC 02 S) (https://labomat.eu/gb/manual-film-applicators/90-k-hand-coater-manual-applicators.html). It includes 1 base 240×380 mm with an application surface of 220×340 mm, 8 spiral bars n° 1 (yellow) to n°8 (blue) and an applicator holder. The bar n°8 was used since it generates wet films (before curing) of 0.1 mm.

Curing in an oven at 110° C. for 2h was used to dry the applied mixture and to form the final coatings.

The SEM images, in FIG. 15, show a much more homogenous surface when WP4 (i.e., WP4 #2) was used, compared with coatings of WP3, with a few rounded-shape structures of sub-millimeter size. These rounded structures are due to the formation of bubbles before and during the curing in the formulation that is viscous.

### Analysis of the Coated Substrates

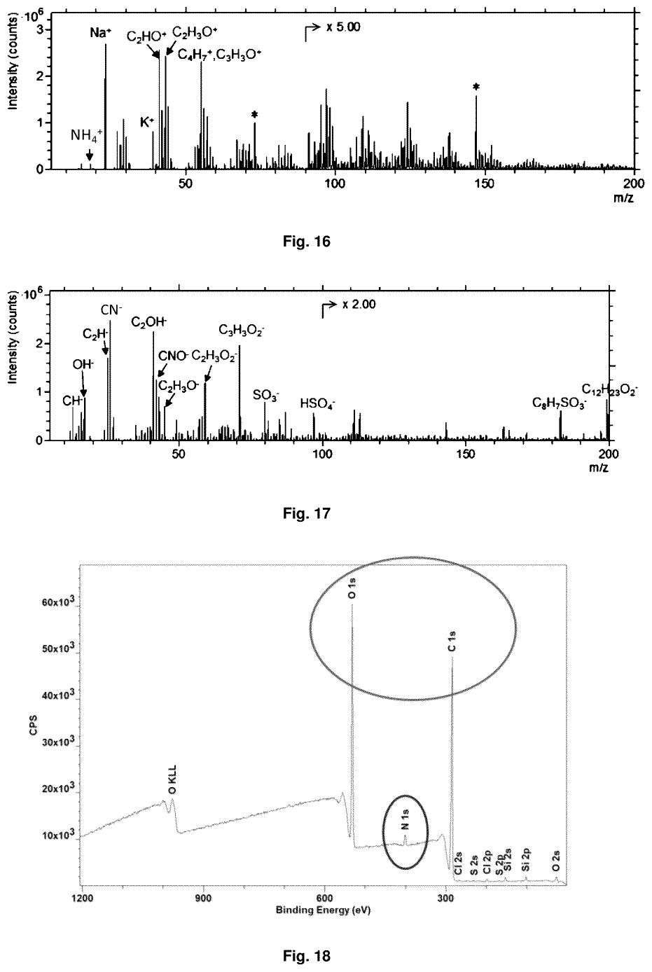

ToF-SIMS spectra acquired on the surface show the presence of cross-linked PVA (C₂HO+, C₂H₃O⁺, C₂OH, C₃H₃O₂⁻) and chitosan (NH₄⁺, CN⁻, CNO⁻) on FIGS. 16 and 17. Lignin is hardly detected due to its low concentration. XPS shows a higher C/O ratio compared with WP3 coatings. This is due to the addition of glyoxal and poly(acrylic acid) as well as the important increase in chitosan concentration, as can be seen on the XPS spectrum displayed in FIG. 18. The data of the XPS spectrum in FIG. 18 are displayed in table 3. The experiments were effected three times to provide the reliability of the results.

TABLE 3
Data of the XPS spectrum of FIG. 18 of a steel
surface coated with WP4 (i.e., WP4 #2)

| Experiment | C 1s | Cl 2p | N 1s | O 1s | S 2p | Si 2p |
|---|---|---|---|---|---|---|
| 1) | 75.4% | 0.1% | 1.5% | 22.1% | 0.1% | 0.8% |
| 2) | 76.0% | 0.1% | 1.6% | 21.3% | <0.1% | 1.0% |
| 3) | 74.1% | 0.2% | 1.8% | 23.0% | 0.1% | 0.8% |

Chitosan is thus detected with the presence of around 2% of nitrogen. It shows that chitosan content was increased by around 20 to reach a few per cents in concentration. S, Si and Cl are mainly due to post-deposition contamination of the coatings. Therefore, antimicrobial effects are mainly due to the presence of chitosan and lignin nanoparticles.

### Roughness Measurements

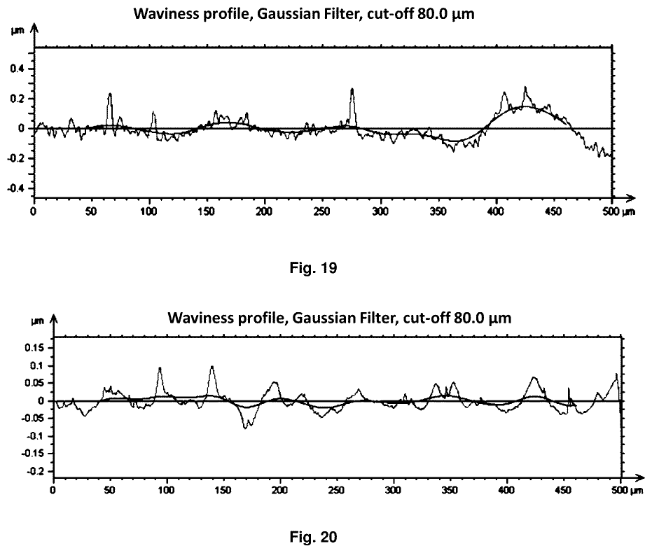

Profilometry studies indicate an average roughness between 0.1 and 0.2 μm on steel (see FIG. 19) and Kapton (see FIG. 20) for optimized coatings. Roughness is higher on steel. When WP4 (i.e., WP4 #2) has been used, it is almost 10 times lower than for coatings from WP3 due to the lack of bubble and the lower coating thickness. Looking at the secondary profile (Ra), seen in tables 4 and 5, roughness is down 50 nm and lower on Kapton again. These results show the higher homogeneity and quality of the optimized coatings. This low roughness will limit the adhesion and growth of pathogens. The thickness was estimated at 1.5 μm by making a scratch crossing the whole coating.

TABLE 4
Profilometry results on steel surface
coated with WP4 (i.e., WP4 #2)
Amplitude parameters - Roughness profile

| | | | |
|---|---|---|---|
| Rp | 0.256 | μm | Gaussian filter, 80 μm |
| Rv | 0.0897 | μm | Gaussian filter, 80 μm |
| Rz | 0.346 | μm | Gaussian filter, 80 μm |
| Rc | 0.104 | μm | Gaussian filter, 80 μm |
| Rt | 0.346 | μm | Gaussian filter, 80 μm |
| Ra | 0.0306 | μm | Gaussian filter, 80 μm |
| Rq | 0.0446 | μm | Gaussian filter, 80 μm |
| Rsk | 2.10 | | Gaussian filter, 80 μm |
| Rku | 10.2 | | Gaussian filter, 80 μm |

Amplitude parameters - Primary profile

| | | |
|---|---|---|
| Pp | 0.363 | μm |
| Pz | 0.499 | μm |
| Pv | 0.135 | μm |
| Pt | 0.499 | μm |
| Pa | 0.0753 | μm |

TABLE 5
Proflimetry results on Kapton surface
coated with WP4 (i.e., WP4 #2)
Amplitude parameters - Roughness profile

| | | | |
|---|---|---|---|
| Rp | 0.0858 | μm | Gaussian filter, 80 μm |
| Rv | 0.0629 | μm | Gaussian filter, 80 μm |
| Rz | 0.149 | μm | Gaussian filter, 80 μm |
| Rc | 0.0644 | μm | Gaussian filter, 80 μm |
| Rt | 0.149 | μm | Gaussian filter, 80 μm |
| Ra | 0.0173 | μm | Gaussian filter, 80 μm |
| Rq | 0.0227 | μm | Gaussian filter, 80 μm |
| Rsk | 0.765 | | Gaussian filter, 80 μm |
| Rku | 4.37 | | Gaussian filter, 80 μm |

Amplitude parameters - Primary profile

| | | |
|---|---|---|
| Pp | 0.101 | μm |
| Pz | 0.241 | μm |
| Pv | 0.140 | μm |
| Pt | 0.241 | μm |
| Pa | 0.0218 | μm |

### Water Contact Angle (WCA) Measurements

WP3 gives an average WCA value of 30°.

WP4 with 6.5 wt. % of Kraft lignin and 0.6 wt. % of graphene oxide (WP4 #3) gives an average WCA value of 48°.

WP4 without graphene oxide (WP4 #2) gives an average WCA value of around 30° C.

These results indicated that the incorporation of graphene oxide allows for increasing the average WCA value of the substrate, subsequently improving the stability of the coating.

### Antimicrobial Properties

The efficiency of the coating of the disclosure was measured against comparative antimicrobial coating C1 and C2, which are respectively NitroPep (which has been developed to inactivate SARS-COV-2 on the surface by the University of Birmingham) and SCS MicroResist® (which is based on parylene, a biocompatible polymer often applied to protect electrical circuits).

The bacteria that were used for achieving experiments are E. coli (ATCC8739) and S. aureus (ATCC6538P).

In a first batch of experiments, the surface of the substrate that has been coated amounts to 100 cm². In a second batch, the surface area has been increased to 625 cm² (surface area of A4 sheet).

Although according to the Japanese Industrial Standard (JIS) Z 2801:2010, a material is called antimicrobial when the log 10-reduction is ≥2 log₁₀,—see Japanese Industrial Standard. Z 2801:2010 ICS 07.100.10; 11.100 Descriptors: Bacteriocide Activity Determination, Microbiological-Resistance Tests, Biological Hazards, Culture Techniques. Available online: https://pdf4pro.com/view/antimicrobial-products-test-for-antimicrobial-aade.html (accessed on Apr. 29, 2022)—it was chosen to apply a first threshold of 3 log 10 to assess the antimicrobial effect and a second threshold of 4 log 10 to assess a high antimicrobial effect. These arbitrary thresholds allow to obtain more significant results.
→on plastic material, such as Kapton

The antimicrobial tests have been performed according to ISO 22196 norm.

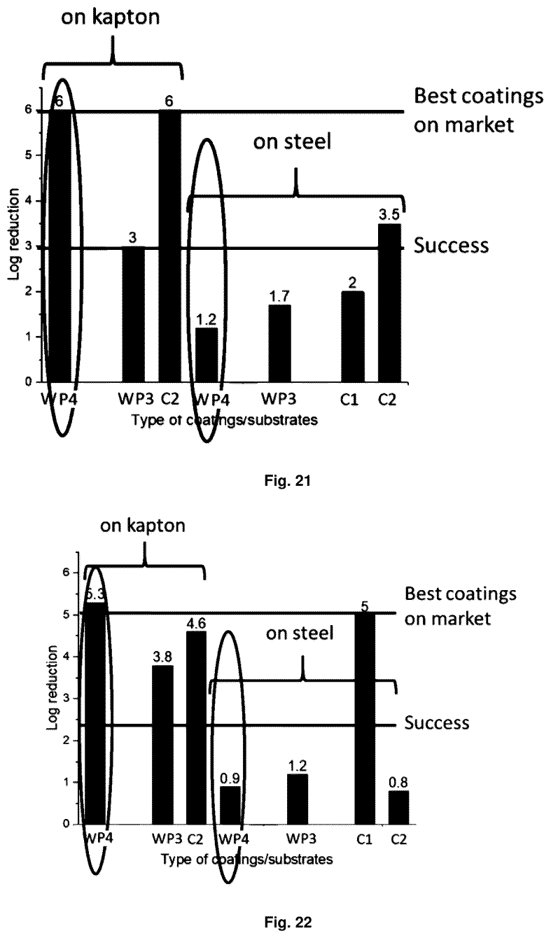

Using a WP4 (i.e., WP4 #2) coating on Kapton with PAA and with a lignin concentration of 0.75 wt. % based on the total weight of the coating, it was demonstrated a strong antibacterial effect on bacteria E. coli, with about 6 log reduction (in fact, 6.12 log reduction) (see FIG. 21, column 1). The antibacterial effect was much weaker when the WP3 solution was used, where only a 3 log reduction has been observed.

Similar results were obtained on Kapton against the bacterium S. aureus, with more than 5 log reduction (5.3 log reduction) when the WP4 (i.e., WP4 #2) coating with a lignin concentration of 0.75 w. % was used (see FIG. 22, column 1). The WP3 coating, comprising boric acid instead of glyoxal, shows a good antibacterial effect (3.8 log reduction) which is nevertheless inferior to the one of WP4 (i.e., WP4 #2).

WP4 (i.e., WP4 #2) offers therefore an antimicrobial coating that is efficient on plastic-type material, such as Kapton, against a wide range of bacteria, notably against both E. coli and S. aureus, attaining a level in an antibacterial activity that a single commercial coating cannot reach for both strains. Indeed, against E. coli, antimicrobial coating C2 (i.e., SCS MicroResist®) has the same level of activity as WP4 (i.e., WP4 #2) (i.e., about 6 log reduction), while against S. aureus, the antimicrobial coating C2 has a log reduction of 4.6, namely inferior to the one of WP4 (i.e., WP4 #2).

It was also demonstrated that when no PAA was added to the coating, the coating on WP4 (i.e., WP4 #1) on Kapton has provided a log reduction of 5.3 against S. aureus, indicating subsequently that the PAA is not necessary to the composition of the coating for attaining the antimicrobial effect.
→on metallic material, such as steel

When applied on a stainless steel surface (in particular steel AISI 304), the results have shown that the antimicrobial coatings were not efficient, probably due to a lack of adhesion of the coating to the metallic surface. Indeed, against E. coli., the coating of WP4 (i.e., WP4 #2) results only in 1.2 log reduction, while against S. aureus, it results only in 0.9 log reduction. To improve the adhesion of the coating on the metallic surface, a bigger surface area was used. In the following experiments, a surface area of 625 cm² has been used (instead of the previously used surface area of 100 cm²).

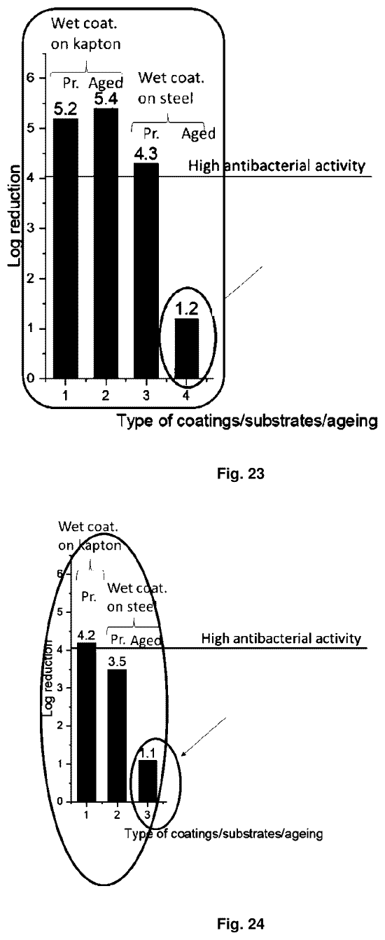

FIG. 23, column 1, indicates that the coating of WP4 (i.e., WP4 #2) on a large surface of Kapton shows, in pristine conditions (Pr) (i.e., directly after coating, namely before ageing in a climatic chamber), a 5.2 log reduction against E. coli.

FIG. 23, column 3 also indicates that the coating of WP4 (i.e., WP4 #2) on stainless steel (in particular steel AISI 304) shows, in pristine conditions (Pr), a 4.3 log reduction against E. coli, demonstrating thus an important antibacterial effect. The bigger area of the coated surface appears, in that case, to have significantly improved the adhesion of the coating, leading therefore to a far bigger efficiency of the coating against E. coli when compared with a smaller surface area.

The stability of the antimicrobial coating of the present disclosure was studied by performing ageing experiments.

Ageing performances were determined on such a bigger surface since they prevail for the adhesion of the coating. Ageing of 3.5 months, simulating more than 5 years of utilization in a harsh environment (55° C., 60% humidity) was carried out. This ageing test was performed according to ASTM F1980-16. On Kapton (see FIG. 23, column 2), the 5.2 log reduction increases to 5.4 log reduction (namely within the variability threshold). On steel (see FIG. 23, column 4), the 4.3 log reduction decreases to a 1.2 log reduction, indicating that the adhesion of the coating on the metallic surface is still not permanent (because the measured log reduction is below the threshold of 2 log reduction) although it has been considerably improved by increasing the surface area.

FIG. 24 shows the results of the coating of WP4 (i.e., WP4 #2) on a substrate exhibiting an area of 625 cm² against S. aureus. When the used substrate is Kapton (FIG. 24, column 1), a 4.2 log reduction has been observed in pristine conditions. On steel (i.e., steel AISI 304), a 3.5 log reduction has been observed in pristine conditions, indicating a good antibacterial effect, but as noticed previously, less good than if a plastic material would have been used (see FIG. 24, column 2). After ageing experiments, (similar to those achieved and reported in FIG. 23), a large inhibition of the antimicrobial effect has been observed since only a 1.1 log reduction was obtained, confirming the results obtained against E. coli (see FIG. 24, column 3).

1-25. (canceled)

26. Antimicrobial coating comprising one or more biosourced polycationic polymers and lignin nanoparticles dispersed into polyvinyl alcohol, characterized in that said antimicrobial coating comprises polyacrylic acid and further comprises a dialdehyde or a boron-based compound, wherein said one or more biosourced polycationic polymers are selected from one or more of chitosan, gelatine, cellulose, dextran, poly(2-N-N-dimethylaminoethylmethacrylate), poly-L-lysine, poly(ethyleneimine), or poly(amidoamine).

27. Antimicrobial coating according to claim 26, characterized in that it comprises polyacrylic acid in an amount ranging between 5 wt. % and 30 wt. % based on the total weight of the coating.

28. Antimicrobial coating according to claim 26, characterized in that said lignin nanoparticles are Kraft lignin nanoparticles.

29. Antimicrobial coating according to claim 26, characterized in that said lignin nanoparticles are present in an amount ranging between 0.1 wt. % and 10 wt. % of the total weight of the coating.

30. Antimicrobial coating according to claim 26, characterized in that said dialdehyde or said boron-based compound is present in an amount ranging between 3 wt. % and 15 wt. % based on the total weight of the coating.

31. Antimicrobial coating according to claim 26, characterized in that said one or more biosourced polycationic polymers are present in an amount ranging between 1 wt. % and 40 wt. % based on the total weight of the coating.

32. Antimicrobial coating according to claim 26, characterized in that said polyvinyl alcohol is present in the coating in an amount ranging between 30 wt. % and 90 wt. % based on the total weight of the coating.

33. Antimicrobial coating according to claim 26, characterized in that it further comprises graphene oxide.

34. Antimicrobial coating according to claim 33, characterized in that said graphene oxide is present in an amount ranging between 0.1 wt. % and 5 wt. % of the total weight of the coating.

35. Antimicrobial coating according to claim 26, characterized in that said lignin nanoparticles are Kraft lignin nanoparticles; wherein said Kraft lignin nanoparticles have an average diameter size ranging from 9 nm up to 70 nm as determined by imaging techniques.

36. Method for producing an antimicrobial coating as defined in claim 26, characterized in that said method comprises the following steps:
a. providing an aqueous solution of lignin nanoparticles,
b. heating said aqueous solution of lignin nanoparticles at a temperature ranging between 60° C. and 80° C.;
c. adding polyvinyl alcohol to said aqueous solution;
d. adding one or more biosourced polycationic polymers;
e. adding a dialdehyde or a boron-based compound once said one or more biosourced polycationic polymers added in step (d) are dissolved;
wherein steps (b) to (e) are conducted under stirring and wherein a step of adding polyacrylic acid is performed between steps (c) and (d).

37. Process for coating a substrate with an antimicrobial coating as defined in claim 26, said process being characterized in that it comprises the following steps:
i. providing a substrate with a surface-to-be-coated;
ii. cleaning said surface under cleaning conditions to obtain a clean surface-to-be-coated;
iii. applying an aqueous mixture of one or more cationic polymers and ethanol onto said clean surface-to-be-coated to obtain an activated surface-to-be-coated;
iv. drying the activated surface-to-be-coated;
V. coating the activated surface-to-be-coated with an antimicrobial coating, as defined in any one of claims 1 to 10, and
vi. curing to obtain the coated surface.

38. The process according to claim 37, characterized in that the cleaning conditions of step (b) comprise the sub-steps of immersing the substrate in an alkaline soap solution, sonicating and then rinsing with deionized water followed by drying.

39. The process according to claim 37, characterized in that said process further comprises a step of dry-cleaning the surface-to-be-coated with an inert gas before step (c).

40. The process according to claim 37, characterized in that the aqueous mixture of the one or more cationic polymers and ethanol comprises an amount of cationic polymer ranging between 5 wt. % and 30 wt. % of the total weight of said aqueous mixture of the one or more cationic polymers and ethanol.

41. The process according to claim 40, characterized in that one cationic polymer is poly(ethylene imine).

42. The process according to claim 37, characterized in that the step (v) of coating is performed through one method selected from bar-coating, blade-coating, or slot die-coating.

43. The process according to claim 37, characterized in that the step (vi) of curing is performed during a period ranging between 1 hour and 12 hours.

44. The process according to claim 37, characterized in that the step (vi) of curing is performed at a temperature ranging between 60° C. and 120° C.

45. The process according to claim 37, characterized in that said substrate has a surface area of at least 50 cm².

46. The process according to claim 37, characterized in that said substrate is in a material selected from plastic, metal, steel, ceramic, wood or textile.

47. Use of an antimicrobial coating, as defined in claim 26 and/or as produced, for protecting an internal surface of a space shuttle, or an external surface of a medical device, or an external surface of a fabric seat, or a plastic material, or a ceramic material.
